(19) United States
(12) Patent Application Publication
(10) Pub. No.: US 2022/0312784 A1
(43) Pub. Date: Oct. 6, 2022

(54) BARRIER FILM COMPOSITION

(71) Applicant: Apeel Technology, Inc., Goleta, CA (US)

(72) Inventors: Krishnan Chari, Santa Barbara, CA (US); Justin Ryan, Goleta, CA (US); Matthew Lee, Goleta, CA (US); Taylor Person, Goleta, CA (US); Stephen Kaun, Goleta, CA (US); Gigi Lin, Goleta, CA (US)

(21) Appl. No.: 17/709,239

(22) Filed: Mar. 30, 2022

Related U.S. Application Data
(60) Provisional application No. 63/167,865, filed on Mar. 30, 2021.

(51) Int. Cl. A23B 7/16; A23B 7/154

(52) U.S. Cl. CPC A23B 7/16; A23B 7/154; A23V 2002/00

(57) ABSTRACT

Presented herein are barrier film compositions that can be used to extend the shelf life of agricultural products. The barrier film compositions can comprise a monoglyceride, a fatty acid or a salt thereof, a biopolymer, and water and have a yield stress of at least 0.1 Pa.

### CROSS-REFERENCE TO RELATED APPLICATION

The application claims the benefit of priority to U.S. Patent Application No. 63/167,865, filed on Mar. 30, 2021, the entire contents of which are hereby incorporated by reference.

### TECHNICAL FIELD

This invention relates to improving the shelf life of plant matter, and more particularly to extending the shelf life of plant matter by application of a barrier film.

### BACKGROUND

Plant matter, such as agricultural products, can be susceptible to spoilage (e.g., degradation and decomposition). Such degradation and/or decomposition can occur via evaporative moisture loss from an external surface of the plant matter to the atmosphere or respiration (e.g., ripening). Degradation and/or decomposition of plant matter can decrease the quality and make the plant mater less desirable. Many types of plant matter have windows of time of ripeness and/or quality. Many types of plant matter have short windows of time when the quality of the plant matter peaks, and/or short windows of time of availability. Since many agricultural products are seasonal and/or have short windows of time of optimal quality, it may be desirable to delay the degradation and/or decomposition of the plant matter in order to increase the effective shelf life and/or to make the plant matter available to consumers during times that they would not otherwise be available.

Conventional approaches to prevent degradation, maintain quality, and increase the shelf life of plant matter include special packaging and/or refrigeration. These approaches can be expensive and may require active management. Furthermore, respiration of plant matter is an exothermic process. Heat released during transit and storage requires active cooling of the storage space, which is a major cost driver for shipping companies.

There exists a need for new approaches to prevent degradation, reduce the generation of heat and humidity, maintain quality, and increase the shelf life of plant matter. Such approaches may require, for example, special packaging or edible barrier coatings, or less or no refrigeration. These and other approaches would be beneficial to stakeholders throughout the supply chain.

### SUMMARY

Provided herein are compositions for barrier film composition and methods for coating plant matter in a barrier film composition.

Embodiment 1 is a barrier film composition comprising: a monoglyceride; a fatty acid or a salt thereof; a biopolymer; and water, wherein the barrier film composition has a yield stress of at least 0.1 Pa as assessed by oscillatory rheology at 1 Hz and 25° C.

Embodiment 2 is the barrier film composition of embodiment 1, wherein the yield stress is about 0.1 Pa to about 6 Pa, about 2 Pa to about 5 Pa, about 0.3 Pa to about 0.7 Pa, or about 0.8 Pa to about 1.4 Pa.

Embodiment 3 is the barrier film composition of embodiment 1 or embodiment 2, wherein the viscosity of the barrier film composition is about 0.001 Pa·s to about 0.1 Pa·s at a shear rate of 5000 s⁻¹ and at a temperature of 25° C.

Embodiment 4 is the barrier film composition of any one of embodiments 1-3, wherein the barrier film composition comprises about 5 g/L to about 150 g/L of the monoglyceride.

Embodiment 5 is the barrier film composition of any one of embodiments 1-4, wherein the barrier film composition comprises about 0.1 g/L to about 10 g/L of the fatty acid or the salt thereof.

Embodiment 6 is the barrier film composition of any one of embodiments 1-5, wherein the barrier film composition comprises about 1.5 g/L to about 8 g/L of the biopolymer.

Embodiment 7 is the barrier film composition of any one of embodiments 1-6, wherein the biopolymer comprises a polysaccharide, a protein, or a combination thereof.

Embodiment 8 is the barrier film composition of any one of embodiments 1-7, wherein the biopolymer comprises xanthan gum, guar gum, pectin, gum Arabic, carrageenan, potassium alginate, ammonium alginate, calcium alginate, sodium alginate, agar, cellulose, starch, chitosan, or a combination thereof.

Embodiment 9 is the barrier film composition of embodiment 1-7, wherein the biopolymer comprises soy protein isolate, wheat gluten, collagen, whey protein isolate, albumen, zein, chickpea protein isolate, caseinate, gelatin, or a combination thereof.

Embodiment 10 is the barrier film composition of any one of embodiments 1-9, wherein the monoglyceride has a carbon chain length of about C10 to about C20.

Embodiment 11 is the barrier film composition of any one of embodiments 1-10, further comprising one or more wetting agents.

Embodiment 12 is the barrier film composition of any one of embodiments 1-11, further comprising an anionic surfactant.

Embodiment 13 is the barrier film composition of embodiment 12, wherein the anionic surfactant comprises sodium decyl sulfate, sodium N-lauroyl-N-methyltaurate, sodium tetradecyl sulfate, sodium dodecyl sulfate, or a combination thereof.

Embodiment 14 is the barrier film composition of any one of embodiments 1-13, further comprising a preservative, a stabilizer, a buffer, a vitamin, a mineral, a pH modifier, a salt, a pigment, a fragrance, an enzyme, a catalyst, an anti-oxidant, an antifungal, an antimicrobial, or a combination thereof.

Embodiment 15 is a method of coating plant matter, the method comprising: applying the barrier film composition of any one of embodiments 1-14 to a surface of the plant matter.

Embodiment 16 is the method of embodiment 15, wherein applying the barrier film composition to the surface of the plant matter comprises dipping the plant matter into the barrier film composition or spraying the barrier film composition onto the surface of the plant matter.

Embodiment 17 is the method of embodiment 15 or embodiment 16, wherein following application of the barrier film composition, the rate of water loss from the plant matter is reduced.

Embodiment 18 is the method of any one of embodiments 15-17, wherein following application of the barrier film composition, the rate of CO₂ production by the plant matter is reduced.

Embodiment 19 is the method of any one of embodiments 15-18, wherein following application of the barrier film composition, the rate of mass loss of the plant matter is reduced.

Embodiment 20 is the method of any one of embodiments 15-19, further comprising allowing the barrier film composition to at least partially evaporate for a period time of about 30 seconds to about 180 seconds.

Embodiment 21 is the method of any one of embodiments 15-20, wherein the plant matter comprises a fruit, a vegetable, a leaf, a stem, bark, a seed, a flower, a peel, a root, or a combination thereof.

Embodiment 22 is an agricultural product comprising a coating of the barrier film composition of any one of embodiments 1-14 on a surface of the agricultural product.

Embodiment 23 is the agricultural product of embodiment 22, wherein the agricultural product has been portioned.

Embodiment 24 is the agricultural product of embodiment 22 or embodiment 23, wherein the agricultural product comprises meat, plant matter, fungus, or a combination thereof.

Embodiment 25 is the agricultural product of embodiment 24, wherein the meat comprises beef, lamb, poultry, pork, fish, shell-fish, boar, bison, deer, elk, camel, boar, rodent, or a combination thereof.

Embodiment 26 is the agricultural product of embodiment 24, wherein the plant matter comprises a fruit, a vegetable, a leaf, a stem, bark, a seed, a flower, a peel, a root, or a combination thereof.

Embodiment 27 is a coated agricultural product, comprising: an agricultural product having a surface; and a coating on the surface of the agricultural product, wherein the coating comprises: a monoglyceride, a fatty acid or a salt thereof, a biopolymer, and water.

Embodiment 28 is the coated agricultural product of embodiment 27, wherein the coating comprises about 5 g/L to about 150 g/L of the monoglyceride.

Embodiment 29 is the coated agricultural product of embodiment 27 or embodiment 28, wherein the coating comprises about 0.1 g/L to about 10 g/L of the fatty acid or the salt thereof.

Embodiment 30 is the coated agricultural product of any one of embodiments 27-29, wherein the biopolymer comprises xanthan gum, guar gum, pectin, gum arabic, carrageenan, potassium alginate, ammonium alginate, calcium alginate, sodium alginate, agar, cellulose, starch, chitosan, or a combination thereof.

Embodiment 31 is the coated agricultural product of any one of embodiments 27-30, wherein the monoglyceride has a carbon chain length of about C10 to about C20.

Embodiment 32 is the coated agricultural product of any one of embodiments 27-31, wherein the coating further comprises one or more wetting agents.

Embodiment 33 is the coated agricultural product of any one of embodiments 27-32, wherein the coating further comprises an anionic surfactant and/or wherein the anionic surfactant comprises sodium decyl sulfate, sodium N-lauroyl-N-methyltaurate, sodium tetradecyl sulfate, sodium dodecyl sulfate, or a combination thereof.

Embodiment 34 is the coated agricultural product of any one of embodiments 27-33, wherein the coating further comprises a preservative, a stabilizer, a buffer a vitamin, a mineral, a pH modifier, a salt, a pigment, a fragrance, an enzyme, a catalyst, an anti-oxidant, an antifungal, an antimicrobial, or a combination thereof.

Embodiment 35 is the coated agricultural product of any one of embodiments 27-34, wherein the agricultural product comprises meat, plant matter, fungus, or a combination thereof.

Embodiment 36 is the coated agricultural product of embodiment 35, wherein the meat comprises beef, lamb, poultry, pork, fish, shell-fish, boar, bison, deer, elk, camel, boar, rodent, and a combination thereof.

Embodiment 37 is the coated agricultural product of embodiment 36, wherein the plant matter comprises a fruit, a vegetable, a leaf, a stem, bark, a seed, a flower, a peel, a root, or a combination thereof.

Embodiment 38 is a method of coating an agricultural product, the method comprising: applying a first coating composition onto a surface of an agricultural product to yield a coated agricultural product, wherein the first coating composition comprises a biopolymer and water; and applying a second coating to the surface of coated agricultural product.

Embodiment 39 is the method of embodiment 38, wherein the biopolymer comprises xanthan gum, guar gum, pectin, gum arabic, carrageenan, potassium alginate, ammonium alginate, calcium alginate, sodium alginate, agar, cellulose, starch, chitosan, or a combination thereof.

Embodiment 40 is the method of embodiment 38 or embodiment 39, further comprising allowing the first coating to dry for a length of time prior to applying the second coating to the surface of coated agricultural product.

Embodiment 41 is the method of embodiment 40, wherein the length of time is about 40 minutes to about 80 minutes.

Embodiment 42 is the method of any one of embodiments 38-41, further comprising allowing the first coating to dry at a temperature of about 30° C. to about 50° C. prior to applying the second coating.

Embodiment 43 is the method of any one of embodiments 38-42, wherein applying the second coating to the surface of the coated agricultural product comprises dipping the coated agricultural product into the second coating, or spraying the second coating onto the surface of the coated agricultural product.

Embodiment 44 is the method of any one of embodiments 38-43, wherein following application of the second coating, the rate of water loss from the agricultural product is reduced.

Embodiment 45 is the method of any one of embodiments 38-44, wherein following application of second coating, the rate of CO₂ production by the agricultural product is reduced.

Embodiment 46 is the method of any one of embodiments 38-45, wherein following application of the second coating, the rate of mass loss of the agricultural product is reduced.

### Definitions

The term “pH modifier” refers to a compound that alters the pH of a composition.

The term “surfactant” refers to a compound that that reduces the surface tension between two liquids, between a gas and a liquid, or between a liquid and a solid.

The term “wetting agent” refers to a substance that reduces the surface tension of water or other liquid to allow it to spread onto a surface and increases the spreadability of the water or liquid.

The term “network forming polysaccharide” refers to a polysaccharide that has the ability to build up a physical network, for example, a network similar to a crosslinked gel.

In some cases, the network forming polysaccharide can also form networks with other large molecules (e.g., proteins).

The term “antimicrobial” refers to a compound that inhibits or slows the growth of microorganisms, such as bacteria, fungi, and viruses.

As used herein, the “respiration rate” of plant matter refers to the rate at which the plant matter releases CO₂, and more specifically is the volume of CO₂ (at standard temperature and pressure) released per unit time per unit mass of the plant matter. In some embodiments, the respiration rate of plant matter can be measured by placing the product in a closed container of known volume that is equipped with a CO₂ sensor, recording the CO₂ concentration within the container as a function of time, and then calculating the rate of CO₂ release required to obtain the measured concentration values. In some cases, the respiration rate of multiple units of plant matter in a volume (e.g., a sealed or semi-sealed volume) is measured in a single measurement (e.g., as an average). It is understood that respiration rate may be determined by indirect methods, including, but not limited to, hyperspectral imaging, NIR, and other imaging or characterization processes.

As used herein, the term “plant matter” refers to any portion of a plant, including, for example, fruits (in the botanical sense, including fruit peels and juice sacs), vegetables, leaves, stems, barks, seeds, flowers, peels, roots, or oils. Plant matter includes pre-harvest plants or portions thereof as well as post-harvest plants or portions thereof, including, e.g., harvested fruits and vegetables, harvested roots and berries, and picked flowers.

The term “mass loss rate” refers to the rate at which the product loses mass (e.g. by releasing water and other volatile compounds). The mass loss rate is typically expressed as a percentage of the original mass per unit time (e.g. percent per day).

The term “mass loss factor” refers to the ratio of the average mass loss rate of uncoated plant matter (measured for a control group) to the average mass loss rate of the corresponding tested plant matter (e.g., coated plant matter) over a given time. Hence a larger mass loss factor for a coated plant matter corresponds to a greater reduction in average mass loss rate for the coated plant matter.

As used herein, “fatty acid derivative” is a hydrocarbon chain comprising an ester, acid, or carboxylate group, collectively referred to as “oxycarbonyl moieties”, bonded to one terminus of the hydrocarbon chain, understood to be the “hydrophilic” end; while the opposite terminus is understood to be the “hydrophobic” end. Fatty acid derivatives include fatty acids, fatty acid esters (e.g., monoglycerides), and fatty acid salts.

All publications, patents, patent applications, and information available on the internet and mentioned in this specification are herein incorporated by reference to the same extent as if each individual publication, patent, patent application, or item of information was specifically and individually indicated to be incorporated by reference. To the extent publications, patents, patent applications, and items of information incorporated by reference contradict the disclosure contained in the specification, the specification is intended to supersede and/or take precedence over any such contradictory material.

Where values are described in terms of ranges, it should be understood that the description includes the disclosure of all possible sub-ranges within such ranges, as well as specific numerical values that fall within such ranges irrespective of whether a specific numerical value or specific sub-range is expressly stated.

The term “each,” when used in reference to a collection of items is intended to identify an individual item in the collection but does not necessarily refer to every item in the collection, unless expressly stated otherwise.

### DESCRIPTION OF DRAWINGS

The following drawings illustrate certain embodiments of the features and advantages of this disclosure. These embodiments are not intended to limit the scope of the appended claims in any manner.

FIG. 1 is a plot of mass loss factor of avocados treated with the barrier film, avocados with a control coating, and untreated avocados.

FIG. 2 is a plot of the CO₂ production rate of avocados treated with the barrier film, avocados with a control coating, and untreated avocados.

FIG. 3 is a plot of mass loss factor of avocados treated with control coatings and untreated avocados.

FIG. 4. is a plot of the CO₂ production rate of avocados treated with control coatings and untreated avocados.

FIG. 5. is a plot of viscosity versus shear rate of solutions of 0.20% w/v xanthan gum, 0.25% w/v xanthan gum, 0.35% w/v xanthan gum, and 0.5% w/v xanthan gum.

FIG. 6 is a plot of mass loss factor avocados coated in barrier films having a mixture of monoglyceride and a fatty acid or salt thereof (sample G), a mixture of monoglyceride, a fatty acid or salt thereof, and a rheology modifier (sample H), a mixture of monoglyceride, a fatty acid or salt thereof, and a wetting agent (sample J), a mixture of monoglyceride, a fatty acid or salt thereof, and a wetting agent, and a rheology modifier (samples K), and untreated avocados.

FIG. 7 is a plot of mass loss factor of chitosan treated (gray data) and untreated (white data) Californian avocados.

FIG. 8 is a plot of respiration of chitosan treated (gray data) and untreated (white data) Californian Avocados.

FIG. 9 is a plot of respiration/mass loss of chitosan treated (gray data) and untreated (white data) Californian avocados.

FIG. 10 is a plot of mass loss factor of chitosan concentration of treated (gray data) and untreated (white data) Mexican avocados.

FIG. 11 is a plot of respiration of chitosan concentration of treated (gray data) and untreated (white data) Mexican avocados.

FIG. 12 is a plot of respiration/mass loss of chitosan treated (gray data) and untreated (white data) Mexican avocados.

FIG. 13 is a plot of respiration of chitosan concentration of treated (gray data) and untreated (white data) Peruvian avocados.

FIG. 14 is a plot of mass loss factor of chitosan concentration of treated (gray data) and untreated (white data) bosc pears.

FIG. 15 is a plot of respiration of chitosan concentration of treated (gray data) and untreated (white data) bosc pears.

FIG. 16 is a plot of respiration/mass loss of chitosan treated (gray data) and untreated (white data) bosc pears.

FIG. 17 is a plot of mass loss factor respiration matching with chitosan on Mexican avocados.

FIG. 18 is a plot of respiration matching with chitosan treated (gray data) and untreated (white data) on Mexican avocados.

FIG. 19 is a plot of respiration matching with chitosan treated (gray data) and untreated (white data) on Mexican avocados.

FIG. 20 is a plot of water vapor transmission measured by change in mass versus elapsed time of Avocados coated with calcium alginate (triangles) and calcium alginate and a mixture of monoglyceride, a fatty acid or salt thereof (circles).

FIG. 21 is a plot that shows change in yield stress at a given oscillation strain of the barrier film composition of Table 5 at 5 days (square), 2 days (triangle), and fresh (circle).

FIG. 22 shows the desiccation barrier effect of the barrier film composition of Table 5 on Haas avocados.

FIG. 23 shows the respiration (CO₂ production rate) of the barrier film composition of Table 5 on Haas avocados.

FIG. 24 Shows the shear elasticity with dispersion age of the barrier film composition prepared with a mixture of short and long-chain monoglycerides, fatty acid salts, and soy protein isolate as denoted in Table 5.

FIG. 25 Shows loss factor trends with dispersion age of the barrier film composition prepared with a mixture of short and long-chain monoglycerides, fatty acid salts, and soy protein isolate as denoted in Table 5.

FIG. 26 shows avocados coated with the soy protein isolate dispersion described in Table 5 impart more shine than those without the described dispersion or the aged dispersion.

### DETAILED DESCRIPTION

### Composition Embodiments

Agricultural products can include meats, fungi, and plant matter such as fresh produce, and flowers (among others). Plant matter as agricultural products can have differing availability to consumers due to variabilities in growing seasons and rates of ripening. Rates of ripening and variabilities in growing season and location can affect the shelf life of the agricultural product. The shelf life of such agricultural products can be limited as the desirability of the agricultural product can decrease. For example, plant matter can desiccate and have a withered dry appearance and texture as the plant matter loses mass (e.g., water). Plant matter (e.g., produce, flowers, etc.) can also become ripe quickly which can make the purchase of the plant matter undesirable as the produce may spoil before it has reached its destination and/or been consumed. Further, the ripening and desiccation of the agricultural product may make transport difficult as the agricultural product may grow a distance away from the point of consumption, thus requiring time for transport. The application of a barrier film composition to the surface of plant matter can, in some examples, reduce a rate of CO₂ production (e.g., respiration) and/or reduce the rate of mass loss from the plant matter. An edible barrier coating composition coating agricultural products can increase shelf life of the plant matter by decreasing mass loss and CO₂ production.

Plant matter (or agricultural products) such as fruit, vegetables, and flowers come in a variety of shapes, and textures. The surface of most plant matter is hydrophobic and water-based materials do not spread evenly over the surface of the plant matter. An objective of a barrier film composition is to achieve uniform coating of the barrier film composition on the surface of the plant matter. Sagging and dripping of the barrier film composition can affect a uniform application. Sagging is associated with the action of gravitational forces on a fluid applied to an inclined (e.g., not flat or level) surface. Sagging can result in some areas of the plant matter having little or no barrier film coverage and other areas having thicker barrier film coverage. It is desirable for a barrier film composition that reduces or avoids sagging and dripping. In some instances, uneven application can result in an unappealing appearance, uneven ripening, or desiccation of the plant matter.

Wetting agents and cling agents can be added to a barrier film composition to improve uniformity of coating. To improve the uniform wetting of the plant matter, some barrier films may include a wetting agent. To reduce or prevent sagging and dripping, a cling agent may be included in some barrier film compositions. A wetting agent can coat the potentially hydrophobic and uneven surface of the agricultural product facilitating the coating of the barrier film composition the surface. For example, the wetting agent can facilitate the spreading on the hydrophobic surface of the plant matter, and the cling agent (e.g., a rheology modifier) can reduce or counteract the effects of gravity.

Described herein are compositions, for example, barrier films, that can be used to improve the shelf life of plant matter and/or other agricultural products, for example, by preventing or delaying the onset of ripening, decreasing desiccation, decreasing respiration, and/or decreasing mass loss. In some embodiments, the compositions comprise a monoglyceride, a fatty acid or a salt thereof, a biopolymer, and water. A wetting agent (e.g., a surfactant) can be added to barrier films to improve the coverage of the barrier film composition on the plant matter.

To improve the cling of the barrier film composition to plant matter, barrier film compositions can include compounds that exhibit yield stress with shear thinning. The terms “shear thinning” or “shear thinning behavior” refers to a decrease in viscosity (i.e., increasing flow rate) with an increasing rate of shear stress. For example, a shear thinning composition (i.e., a composition exhibiting shear thinning behavior) can exhibit a decrease in viscosity (i.e., an increase in flow) upon application of an increasing rate of shear stress.

A yield stress characteristic is a property associated with complex fluids where material does not flow unless applied stress exceeds a certain value. Barrier film compositions can exhibit yield stress characteristics when the barrier film composition is applied to the plant matter.

The elastic modulus of yield stress fluids can be greater than the viscous modulus at low values of applied stress or strain. When the elastic and viscous moduli are measured as a function of increasing stress or strain the network structure of the yield stress fluid breaks, and the viscous modulus exceeds the elastic modulus at a value of applied stress, this value of applied stress is called the yield stress. Said differently, the applied stress corresponding to the intersection of the elastic and viscous moduli is the yield stress.

Various methods of testing and determining yield stress are known in the art and include those described in Larsson et al., Annual Transactions of the Nordic Rheology Society, Vol. 21, 2013. One method of measuring yield stress is to use oscillatory rheology, which can quantify both the viscous and elastic properties. Without being bound by any particular theory, in some embodiments, the yield stress of any of the barrier film compositions described herein are be determined using oscillatory rheology at a frequency of about 1 Hz and a temperature of 25° C.

In some embodiments, the yield stress of the barrier film composition is measured by oscillatory rheology. In some embodiments, the yield stress of the barrier film composition is measured by oscillatory rheology at about 0.1 Hz to about 10 Hz.

In some embodiments, the yield stress of the barrier film composition is measured by oscillatory rheology to be about 0.1 Pa to about 6.0 Pa. In some embodiments, the yield stress of the barrier film composition is measured by oscillatory rheology to be about 0.4 Pa to about 6.0 Pa, about 0.6 Pa to about 6.0 Pa, about 0.8 Pa to about 6.0 Pa, about 1.0 Pa to about 6.0 Pa, about 1.2 Pa to about 6.0 Pa, about 1.4 Pa to about 6.0 Pa, about 1.6 Pa to about 6.0 Pa, about 1.8 Pa to about 6.0 Pa, about 2.0 Pa to about 6.0 Pa, about 2.2 Pa to about 6.0 Pa, about 2.4 Pa to about 6.0 Pa, about 2.6 Pa to about 6.0 Pa, about 2.8 Pa to about 6.0 Pa, about 3.0 Pa to about 6.0 Pa, about 3.2 Pa to about 6.0 Pa, about 3.4 Pa to about 6.0 Pa, about 3.6 Pa to about 6.0 Pa, about 3.8 Pa to about 6.0 Pa, about 4.0 Pa to about 6.0 Pa, about 4.2 Pa to about 6.0 Pa, about 4.4 Pa to about 6.0 Pa, about 4.6 Pa to about 6.0 Pa, about 4.8 Pa to about 6.0 Pa, about 5.0 Pa to about 6.0 Pa, about 5.2 Pa to about 6.0 Pa, about 5.4 Pa to about 6.0 Pa, about 5.6 Pa to about 6.0 Pa, or about 5.8 Pa to about 6.0 Pa.

In some embodiments, the one or more fatty acids, fatty acid esters, or a combination thereof comprise one monoglyceride (e.g., a 1-monoglyceride or a 2-monoglyceride). In some embodiments, the one or more fatty acids, fatty acid esters, or a combination thereof comprise two monoglycerides (e.g., two 1-monoglycerides, two 2-monoglycerides, or one 1-monoglyceride and one 2-monoglyceride).

In some embodiments, the compositions (e.g., the coating agents or coatings) comprise one or more fatty acid derivatives. In some embodiments, the one or more fatty acid derivatives comprise one or more fatty acids, fatty acid esters, or a combination thereof. In some embodiments, the one or more fatty acid derivatives comprise one or more fatty acid salts. In some embodiments, the one or more fatty acid derivatives comprise two or more fatty acids, fatty acid esters, or a combination thereof. In some embodiments, the one or more fatty acid derivatives comprise two or more fatty acid salts. In some embodiments, the one or more fatty acid derivatives comprise one or more fatty acids, fatty acid esters, or a combination thereof and one or more fatty acid salts. In some embodiments, the one or more fatty acid derivatives comprise two or more fatty acids, fatty acid esters, or a combination thereof and two or more fatty acid salts. In some embodiments, the one or more fatty acid derivatives comprise one fatty acid or ester thereof and one fatty acid salt. In some embodiments, the one or more fatty acid derivatives comprise one fatty acid thereof and one fatty acid salt. In some embodiments, the one or more fatty acid derivatives comprise one fatty acid ester and one fatty acid salt. In some embodiments, the one or more fatty acid derivatives comprise two fatty acids, fatty acid esters, or a combination thereof and two fatty acid salts. In some embodiments, the one or more fatty acid derivatives comprise two fatty acid esters and two fatty acid salts. In some embodiments, the one or more fatty acid derivatives comprise two fatty acid esters and one fatty acid salt. In some embodiments, the one or more fatty acid derivatives comprise one fatty acid ester, one fatty acid, and one fatty acid salts. In some embodiments, the one or more fatty acid derivatives comprise one fatty acid ester and one fatty acid salt.

In some embodiments, the one or more fatty acids, fatty acid esters, or a combination thereof comprise one or more fatty acid esters. In some embodiments, the one or more fatty acid esters is one fatty acid ester. In some embodiments, the one or more fatty acid esters is two fatty acid esters.

In some embodiments, the one or more fatty acid salts is one fatty acid salt. In some embodiments, the one or more fatty acid salts is two fatty acid salts.

In some embodiments, the one or more fatty acids, fatty acid esters, or a combination thereof comprise one monoglyceride (e.g., a 1-monoglyceride or a 2-monoglyceride). In some embodiments, the one or more fatty acids, fatty acid esters, or a combination thereof comprise two monoglycerides (e.g., two 1-monoglycerides, two 2-monoglycerides, or one 1-monoglyceride and one 2-monoglyceride).

In some embodiments, the monoglyceride has a carbon chain length of about C10 to about C20. In some embodiments, the monoglyceride has a carbon chain length that comprises one or more of or is selected from the group consisting of a C10 monoglyceride, a C12 monoglyceride, a C14 monoglyceride, a C16 monoglyceride, a C18 monoglyceride, a C20 monoglyceride, and a combination thereof. In some embodiments, the monoglyceride is a saturated monoglyceride. In some embodiments, the saturated monoglyceride is monolaurin, glyceryl monostearate, glycerol monostearate, or glyceryl hydroxystearate.

In some embodiments, the barrier film composition comprises about 2 g/L to about 150 g/L of the monoglyceride. In some embodiments, the barrier film composition comprises about 15 g/L of the monoglyceride to about 150 g/L of monoglyceride, about 25 g/L of the monoglyceride to about 150 g/L of monoglyceride, about 35 g/L of the monoglyceride to about 150 g/L of monoglyceride, about 45 g/L of the monoglyceride to about 150 g/L of monoglyceride, about 55 g/L of the monoglyceride to about 150 g/L of monoglyceride, about 65 g/L of the monoglyceride to about 150 g/L of monoglyceride, about 75 g/L of the monoglyceride to about 150 g/L of monoglyceride, about 85 g/L of the monoglyceride to about 150 g/L of monoglyceride, about 95 g/L of the monoglyceride to about 150 g/L of monoglyceride, about 105 g/L of the monoglyceride to about 150 g/L of monoglyceride, about 110 g/L of the monoglyceride to about 150 g/L of monoglyceride, about 125 g/L of the monoglyceride to about 150 g/L of monoglyceride, about 135 g/L of the monoglyceride to about 150 g/L of monoglyceride, or about 145 g/L of the monoglyceride to about 150 g/L of monoglyceride.

In some embodiments, the fatty acid or salt thereof is a C14 fatty acid or salt thereof, C16 fatty acid or salt thereof, a C18 fatty acid or salt thereof, or a combination thereof. In some embodiments, the fatty acid or salt thereof is a C16 fatty acid or salt thereof, and a C18 fatty acid or salt thereof. In some embodiments, the fatty acid or a salt thereof is saturated. In some embodiments, the fatty acid or salt thereof is unsaturated.

In some embodiments, the fatty acid or salt thereof is lauric acid, myristic acid, palmitic acid, stearic acid, archidic acid, behenic acid, lignoceric acid, palmitoleic acid, caprylic acid, capric acid, cerotic acid, oleic acid, linoleic acid, arachidonic acid, eicosapentaenoic acid, docosahexaenoic acid, myristoleic acid, sapienic acid, elaidic acid, vaccenic acid, linoelaidic acid, α-linolenic acid, erucic acid, docosahexaenoic acid, salts thereof (e.g., sodium salts) or combinations thereof.

In some embodiments, the fatty acid is a fatty acid salt. In some embodiments the fatty acid salt comprises one or more of or is selected from the group consisting of sodium laurate, myristate, sodium palmitate, sodium stearate, archidic acid salt, sodium behenate, lignoceric acid sodium salt, sodium arachidonate, eicosapentaenoic acid sodium salt, docosahexaenoic acid sodium salt, sodium myristate, sapienate, elaidate, linoleic acid sodium salt, linoleic acid sodium salt, sodium erucate, docosahexaenoic acid sodium salt, or combinations thereof.

In some embodiments, the barrier film composition comprises about 0.125 g/L fatty acid or salt to about 10 g/L fatty acid or salt. In some embodiments, the barrier film composition comprises about 0.5 g/L fatty acid or salt to about 10 g/L fatty acid or salt, about 0.5 g/L fatty acid or salt to about 10 g/L fatty acid or salt, about 1.0 g/L fatty acid or salt to about 10 g/L fatty acid or salt, about 1.5 g/L fatty acid or salt to about 10 g/L fatty acid or salt, about 2.0 g/L fatty acid or salt to about 10 g/L fatty acid or salt, about 2.5 g/L fatty acid or salt to about 10 g/L fatty acid or salt, about 3.0 g/L fatty acid or salt to about 10 g/L fatty acid or salt, about 3.5 g/L fatty acid or salt to about 10 g/L fatty acid or salt, about 4.0 g/L fatty acid or salt to about 10 g/L fatty acid or salt, about 4.5 g/L fatty acid or salt to about 10 g/L fatty acid or salt, about 5.0 g/L fatty acid or salt to about 10 g/L fatty acid or salt, about 5.5 g/L fatty acid or salt to about 10 g/L fatty acid or salt, about 6.0 g/L fatty acid or salt to about 10 g/L fatty acid or salt, about 6.5 g/L fatty acid or salt to about 10 g/L fatty acid or salt, about 7.0 g/L fatty acid or salt to about 10 g/L fatty acid or salt, about 7.5 g/L fatty acid or salt to about 10 g/L fatty acid or salt, about 8.0 g/L fatty acid or salt to about 10 g/L fatty acid or salt, about 8.5 g/L fatty acid or salt to about 10 g/L fatty acid or salt, about 9.0 g/L fatty acid or salt to about 10 g/L fatty acid or salt, or about 9.5 g/L fatty acid or salt to about 10 g/L fatty acid or salt.

In some embodiments, the monoglyceride and the fatty acid or salt are combined. In some embodiments, the monoglyceride and the fatty acid or salt are combined in a ratio of about 99% w/w monoglyceride to about 1% w/w fatty acid or salt, about 95% w/w monoglyceride to about 5% w/w fatty acid or salt, about 90% w/w monoglyceride to about 10% w/w fatty acid or salt, about 85% w/w monoglyceride to about 15% w/w fatty acid or salt, about 80% w/w monoglyceride to about 20% w/w fatty acid or salt, about 75% w/w monoglyceride to about 25% w/w fatty acid or salt, about 70% w/w monoglyceride to about 30% w/w fatty acid or salt, about 65% w/w monoglyceride to about 35% w/w fatty acid or salt, about 60% w/w monoglyceride to about 40% w/w fatty acid or salt, about 55% w/w monoglyceride to about 45% w/w fatty acid or salt, about 50% w/w monoglyceride to about 50% w/w fatty acid or salt, about 45% w/w monoglyceride to about 55% w/w fatty acid or salt, about 40% w/w monoglyceride to about 60% w/w fatty acid or salt, about 35% w/w monoglyceride to about 65% w/w fatty acid or salt, about 30% w/w monoglyceride to about 70% w/w fatty acid or salt, about 25% w/w monoglyceride to about 75% w/w fatty acid or salt, about 20% w/w monoglyceride to about 80% w/w fatty acid or salt, about 15% w/w monoglyceride to about 85% w/w fatty acid or salt, about 10% w/w monoglyceride to about 90% w/w fatty acid or salt, or about 5% w/w monoglyceride to about 95% w/w fatty acid or salt.

In some embodiments, the ratio of monoglyceride to fatty acid or salt is about 70% w/w monoglyceride to about 30% w/w fatty acid or salt. In some embodiments, the ratio of monoglyceride to fatty acid or salt is about 95% w/w monoglyceride to about 5% w/w fatty acid or salt. In some embodiments, the ratio of monoglyceride to fatty acid or salt is about 96% w/w monoglyceride to about 4% w/w fatty acid or salt.

In some embodiments, the biopolymer is a polysaccharide, a protein, or a combination thereof. In some embodiments, the biopolymer is a polysaccharide. In some embodiments, the biopolymer is a network forming polysaccharide. In some embodiments, the biopolymer comprises one or more of or is selected from the group consisting of xanthan gum, guar gum, pectin, gum arabic, carrageenan, potassium alginate, ammonium alginate, calcium alginate, sodium alginate, agar, cellulose, starch, chitosan, and a combination thereof. In some embodiments, the biopolymer is xanthan gum. In some embodiments, the biopolymer is chitosan.

In some embodiments, the biopolymer is a protein. In some embodiments, the protein comprises one or more of or is selected from the group consisting of soy protein isolate, wheat gluten, collagen, albumen, zein, whey protein isolate, chickpea protein isolate, caseinate, gelatin, and combinations thereof. See M. H. Tunick, J. Agricultural and Food Chemistry 59, 1481 (2011).

In some embodiments, the barrier film composition comprises about 0.5 g/L biopolymer to about 8 g/L biopolymer. In some embodiments, the barrier film composition comprises about 1.0 g/L biopolymer to about 8.0 g/L biopolymer, about 1.5 g/L biopolymer to about 8.0 g/L biopolymer, about 2.0 g/L biopolymer to about 8.0 g/L biopolymer, about 2.5 g/L biopolymer to about 8.0 g/L biopolymer, about 3.0 g/L biopolymer to about 8.0 g/L biopolymer, about 3.5 g/L biopolymer to about 8.0 g/L biopolymer, about 4.0 g/L biopolymer to about 8.0 g/L biopolymer, about 4.5 g/L biopolymer to about 8.0 g/L biopolymer, about 5 g/L biopolymer to about 8.0 g/L biopolymer, about 5.5 g/L biopolymer to about 8.0 g/L biopolymer, about 6 g/L biopolymer to about 8.0 g/L biopolymer, about 6.5 g/L biopolymer to about 8.0 g/L biopolymer, about 7 g/L biopolymer to about 8.0 g/L biopolymer, or about 7.5 g/L biopolymer to about 8.0 g/L biopolymer.

In some embodiments, the barrier film composition comprises about 5 g/L to about 150 g/L monoglyceride, about 0.1 g/L to about 10 g/L fatty acid salt, about 1.5 g/L to about 5 g/L biopolymer, and water.

For example, a barrier film composition can comprise about 5 g/L to about 150 g/L of a C10 monoglyceride, a C12 monoglyceride, a C14 monoglyceride, a C16 monoglyceride, a C18 monoglyceride, a C20 monoglyceride, and combinations thereof; about 0.1 g/L to about 10 g/L of a C14 fatty acid salt, C16 fatty acid salt, a C18 fatty acid salt, and combinations thereof; about 1.5 g/L to about 5 g/L of a biopolymer; and water.

In some embodiments, the about 5 g/L to about 150 g/L monoglyceride is a saturated monoglyceride. In some embodiments, the about 0.1 g/L to about 10 g/L fatty acid salt is a saturated fatty acid salt. In some embodiments, about 1.5 g/L to about 5 g/L biopolymer is a network forming polysaccharide.

For example, a barrier film composition can comprise about 5 g/L to about 150 g/L of a C10 saturated monoglyceride, a C12 saturated monoglyceride, a C14 saturated monoglyceride, a C16 saturated monoglyceride, a C18 saturated monoglyceride, a C20 saturated monoglyceride, and a combination thereof; about 0.1 g/L to about 10 g/L of a C14 saturated fatty acid salt, C16 saturated fatty acid salt, a C18 saturated fatty acid salt, or a combination thereof; about 1.5 g/L to about 5 g/L of a network forming polysaccharide, and water.

In some embodiments, the about 5 g/L to about 150 g/L monoglyceride is a saturated monoglyceride. In some embodiments, the about 0.1 g/L to about 10 g/L fatty acid salt is a saturated fatty acid salt. In some embodiments, the biopolymer is a protein. For example, a barrier film composition can comprise about 5 g/L to about 150 g/L of a C10 saturated monoglyceride, a C12 saturated monoglyceride, a C14 saturated monoglyceride, a C16 saturated monoglyceride, a C18 saturated monoglyceride, a C20 saturated monoglyceride, and a combination thereof; about 0.1 g/L to about 10 g/L of a C14 saturated fatty acid salt, C16 saturated fatty acid salt, a C18 saturated fatty acid salt, or a combination thereof; about 1.5 g/L to about 5 g/L of a protein, and water.

In some embodiments, the about 5 g/L to about 150 g/L saturated monoglyceride is monolaurin, glyceryl monostearate, glycerol monostearate, or glyceryl hydroxystearate. In some embodiments, the about 0.1 g/L to about 10 g/L saturated fatty acid salt is sodium laurate, myristate, sodium palmitate, sodium stearate, or sodium behenate. In some embodiments, the about 1.5 g/L to about 5 g/L of the network forming polysaccharide is xanthan gum, guar gum, pectin, gum arabic, carrageenan, potassium alginate, ammonium alginate, calcium alginate, sodium alginate, agar, cellulose, starch, or chitosan. For example, a barrier film composition can comprise about 5 g/L to about 150 g/L monolaurin, glyceryl monostearate, glycerol monostearate, or glyceryl hydroxystearate; about 0.1 g/L to about 10 g/L sodium laurate, myristate, sodium palmitate, sodium stearate, archidic acid salt, or sodium behenate; about 1.5 g/L to about 5 g/L of xanthan gum, guar gum, pectin, gum arabic, carrageenan, potassium alginate, ammonium alginate, calcium alginate, sodium alginate, agar, cellulose, starch, chitosan; and water.

In some embodiments, the about 5 g/L to about 150 g/L saturated monoglyceride is monolaurin, glyceryl monostearate, glycerol monostearate, or glyceryl hydroxystearate.

In some embodiments, the about 0.1 g/L to about 10 g/L saturated fatty acid salt is sodium laurate, myristate, sodium palmitate, sodium stearate, or sodium behenate. In some embodiments, the about 1.5 g/L to about 5 g/L of the protein is soy protein isolate, wheat gluten, collagen, albumen, zein, whey protein isolate, chickpea protein isolate, caseinate, or gelatin.

For example, a barrier film composition can comprise about 5 g/L to about 150 g/L monolaurin, glyceryl monostearate, glycerol monostearate, or glyceryl hydroxystearate; about 0.1 g/L to about 10 g/L sodium laurate, myristate, sodium palmitate, sodium stearate, archidic acid salt, or sodium behenate; about 1.5 g/L to about 5 g/L of soy protein isolate, wheat gluten, collagen, albumen, zein, whey protein isolate, chickpea protein isolate, caseinate, or gelatin, and water.

In some embodiments, the about 5 g/L to about 150 g/L saturated monoglyceride is monolaurin, glyceryl monostearate, glycerol monostearate, or glyceryl hydroxystearate. In some embodiments, the about 0.1 g/L to about 10 g/L saturated fatty acid salt is sodium laurate, myristate, sodium palmitate, sodium stearate, or sodium behenate. In some embodiments, the about 1.5 g/L to about 5 g/L of the biopolymer is a combination of protein and network forming polysaccharide comprises one or more of or is selected from the group consisting of soy protein isolate, wheat gluten, collagen, albumen, zein, whey protein isolate, chickpea protein isolate, caseinate, gelatin, xanthan gum, guar gum, pectin, gum arabic, carrageenan, potassium alginate, ammonium alginate, calcium alginate, sodium alginate, agar, cellulose, starch, chitosan, and combinations thereof.

For example, a barrier film composition can comprise about 5 g/L to about 150 g/L monolaurin, glyceryl monostearate, glycerol monostearate, or glyceryl hydroxystearate; about 0.1 g/L to about 10 g/L sodium laurate, myristate, sodium palmitate, sodium stearate, archidic acid salt, or sodium behenate, about 1.5 g/L to about 5 g/L of a combination of protein and network forming polysaccharide comprises one or more of or is selected from the group consisting of soy protein isolate, wheat gluten, collagen, albumen, zein, whey protein isolate, chickpea protein isolate, caseinate, gelatin, xanthan gum, guar gum, pectin, gum arabic, carrageenan, potassium alginate, ammonium alginate, calcium alginate, sodium alginate, agar, cellulose, starch, chitosan, and combinations thereof, and water.

In some embodiments, the about 5 g/L to about 150 g/L saturated monoglyceride is glyceryl monostearate. In some embodiments, the about 0.1 g/L to about 10 g/L saturated fatty acid salt is sodium stearate. In some embodiments, the about 1.5 g/L to about 5 g/L of the protein is whey protein. For example, a barrier film composition can comprise about 5 g/L to about 150 g/L glyceryl monostearate; about 0.1 g/L to about 10 g/L sodium stearate; about 1.5 g/L to about 5 g/L whey protein isolate; and water.

In some embodiments, the about 5 g/L to about 150 g/L saturated monoglyceride is a combination of glycerol monostearate and monolaurin. In some embodiments, the about 0.1 g/L to about 10 g/L saturated fatty acid salt is sodium stearate. In some embodiments, the about 1.5 g/L to about 5 g/L of the protein is soy protein isolate. For example, a barrier film composition can comprise about 5 g/L to about 150 g/L glycerol monostearate and monolaurin; about 0.1 g/L to about 10 g/L sodium stearate; about 1.5 g/L to about 5 g/L soy protein isolate; and water.

In some embodiments, the about 5 g/L to about 150 g/L saturated monoglyceride is glyceryl monostearate. In some embodiments, the about 0.1 g/L to about 10 g/L saturated fatty acid salt is sodium stearate. In some embodiments, the about 1.5 g/L to about 5 g/L of the network forming polysaccharide is xanthan gum. For example, a barrier film composition can comprise about 5 g/L to about 150 g/L glyceryl monostearate; about 0.1 g/L to about 10 g/L sodium stearate; about 1.5 g/L to about 5 g/L xanthan gum, and water.

In some embodiments, the about 5 g/L to about 150 g/L saturated monoglyceride is glyceryl monostearate. In some embodiments, the about 0.1 g/L to about 10 g/L saturated fatty acid salt is sodium stearate. In some embodiments, the about 1.5 g/L to about 5 g/L of the network forming polysaccharide is guar gum. For example, a barrier film composition can comprise about 5 g/L to about 150 g/L glyceryl monostearate; about 0.1 g/L to about 10 g/L sodium stearate; about 1.5 g/L to about 5 g/L guar gum; and water.

In some embodiments, the about 5 g/L to about 150 g/L saturated monoglyceride is glyceryl monostearate. In some embodiments, the about 0.1 g/L to about 10 g/L saturated fatty acid salt is sodium stearate. In some embodiments, the about 1.5 g/L to about 5 g/L of the network forming polysaccharide is chitosan. For example, a barrier film composition can comprise about 5 g/L to about 150 g/L glyceryl monostearate; about 0.1 g/L to about 10 g/L sodium stearate; about 1.5 g/L to about 5 g/L chitosan; and water.

In some embodiments, the barrier film composition further comprises a wetting agent. In some embodiments, the wetting agent is anionic, cationic, amphoteric, nonionic or a combination thereof. In some embodiments, wetting agent is a surfactant. In some embodiments, the surfactant is anionic, nonionic, or zwitterionic. In some embodiments, a surfactant comprises one or more of or is selected from the group consisting of fatty alcohol ethoxylates, amine oxides, sulfoxides, C10-C18 ethoxylated alcohols, C10-C18 ethoxylated propoxylated alcohols, C12-18 ether alcohols, alkyl(C12-C16) alcohol sulfate salt, C10-C18 alkyldimethylamine, benzene salts, monosulfobenzene derivatives, D-glucoside derivatives, C6-C16 alkyl-poly-D-glucosides, D-glucitol or derivatives thereof, C10-16-alkyl glycosides, ethanaminium esters with C16-18 and C18-unsaturated fatty acids, and combinations thereof.

In some embodiments, a surfactant comprises one or more of or is selected from the group consisting of hexadecenoic acid, dodecanesulfonic acid, 1-propanoic acid, eicosenoic acid, acetic acid, oleic acid, oleyamine, ammonium cumene sulfonate, ammonium lauryl sulfate, ammonium xylenesulfonate, 1-methylethyl-benzene, benzenesulfonic acid, coco alkyldimethylbetaine, butanedioic acid, sulfo-butanedioic acid, butanedioic acid disodium salt, butyl D-glucoside, butyl poly-D-glucoside, calcium xylene sulfonate, capric dimethyl amine oxide, ethoxylated castor oil, sulfated castor oil, castor oil sodium salt, cetamine oxide, cetearyl glucoside, cocamidopropyl hydroxysultaine, cocamidopropylamine oxide, cocamine oxide, cyclocarboxypropyloleic acid, D-glucopyranose, 2-hydroxy-3-sulfopropyl ethers, heptyl glucosides, decanoic acid and/or salts thereof, decyl glucoside, octyl-poly-D-glucosides, decyl-poly-D-glucosides, decylbenzenesulfonic acid, diethylene glycol momolauryl ether sodium sulfate, disodium cocoyl glutamate, disodium lauriminodipropionate, distearoylethyl hydroxyethylmonium methosulfate, docosanoic acid, dodecanoic acid and/or salts thereof, dodecene-1-sulfonic acid and salt thereof, dodecyl alcohol, ethoxylated dodecyl alcohol, dodecyl triethylene glycol ether, dodecyl-beta-D-glucoside, dodecylbenzene sulfonic acid, eicosanoic acid, ethanaminium, 2-hydroxy-N,N-bis(2-hydroxyethyl)-N-methyl-ethanaminium and/or salts thereof, ethylene glycol monopalmitate, ethylene glycol monostearate, gardol, glycerine oleate, glyceryl monolaurate, glyceryl monooleate, glyceryl monostearate, glycol distearate, lauramidopropyl betaine, lauramidopropylamine oxide, lauryl glucoside, lauryl hydroxysultaine, lauryl hydroxysultaine, lignoceric acid, linoleic acid, linolenic acid, magnesium lauryl sulfate, magnesium stearate, myristamido propylamine oxide, myristamidopropyl betaine, myristoleic acid, myristyl betaine, n-octyl polyoxyethylene, N-octyl pyrrolidone, octanoic acid, octanoic acid, oleic acid, palmitic acid, palmitoleic acid, poloxalene, polyethylene glycol distearate, polyethylene glycol monocetyl ether, polyethylene glycol stearate, polyoxyethylene dioleate, polyoxyethylene monoleate, polysorbate 80, sodium cocoyl glutamate, sodium cumene sulfonate, sorbitan and derivatives thereof, stearic acid, sulfonic acid and derivatives thereof, tetradecanoic acid, undecyl-D-glucoside, and combinations thereof.

In some embodiments, a surfactant comprises one or more of or is selected from the group consisting of sodium lauryl sulfate, sodium laureth sulfate, ammonium lauryl sulfate, ammonium laureth sulfate, sodium stearate, cocamide monoethanolamine (cocamide MEA), cocamide diethanolamine (cocamide DEA), coco glucoside, decyl glucoside, lauryl glucoside, sodium lauryl glucose carboxylate, sodium cocoyl glutamate, disodium cocoyl glutamate, sodium lauroyl glutamate, sodium cocoyl hydrolyzed wheat protein, or sodium cocoyl hydrolyzed collagen. In some embodiments, a surfactant is an alkyl PEG sulfosuccinate such as disodium laureth sulfosuccinate or disodium deceth sulfosuccinate. In some embodiments, a surfactant is an alkyl sulfosuccinate such as disodium lauryl sulfosuccinate or disodium coco sulfosuccinate. In some embodiments, a surfactant is an amidopropyl betaine such as cocamidopropyl betaine (coco betaine, cocamido betaine). In some embodiments, a surfactant is an alkyl sulfoacetate such as sodium lauryl sulfoacetate. In some embodiments, a surfactant is an alkyl imidazoline such as sodium cocoamphoacetate, sodium cocoamphopropionate, disodium cocoamphodiacetate, or disodium cocoamphodipropionate. In some embodiments, a surfactant is an alkyl taurate such as sodium methyl cocoyl taurate or sodium methyl oleoyl taurate. In some embodiments, a surfactant is an acyl sarcosine such as sodium lauroyl sarcosinate, sodium cocoyl sarcosinate. In some embodiments, a surfactant is an acyl isethionate such as sodium cocoyl isethionate. In some embodiments, a surfactant is a sodium olivate, sodium cocoate, sodium canolate, potassium olivate, potassium canolate, potassium cocoate. In some embodiments, a surfactant is an alkyl ether sulfates such as sodium pareth sulfate or sodium cetareth sulfate.

In some embodiments, any of the barrier film compositions described herein can further comprise one or more additives. In some embodiments, the additive comprises one or more of or is selected from the group consisting of a preservative, a stabilizer, a buffer, a vitamin, a mineral, a pH modifier, a salt, a pigment, a fragrance, an enzyme, a catalyst, an anti-oxidant, an antifungal, an antimicrobial, or a combination thereof.

In some embodiments, the stabilizer is alginic acid, agar, carrageenan, pectin, or combinations thereof.

In some embodiments, the buffer is a citrate salt, a phosphate salt, a tartrate salt, or combinations thereof.

In some embodiments, the preservative is a nitrite derivative or salt thereof, a sulfite derivative or salt thereof, a benzoate derivative or salt thereof, or combinations thereof. In some embodiments, the preservative is butylated hydroxyanisole 320, butylated hydroxytoluene 321, or combinations thereof.

In some embodiments, the vitamin is vitamin A or derivatives thereof, vitamin B or derivatives thereof, vitamin C or derivatives thereof, vitamin D or derivatives thereof, vitamin E or derivatives thereof, or combinations thereof.

In some embodiments, the mineral is a macromineral, a trace mineral, or combinations thereof. In some embodiments, the mineral is iron, manganese, copper, iodine, zinc, cobalt, fluoride, selenium, or combinations thereof.

In some embodiments, the pigment is blue #1, blue #2, green #3, red #3, red #40, yellow #5, yellow #6, citrus red #2, corresponding aluminum lakes thereof, or combinations thereof.

In some embodiments, the enzyme is an enzyme preparation such as a decarboxylase, an aminopeptidase, an amylase, an asparaginase, a carboxypeptidase, a catalase, a cellulase, a chymosin, a cyprosin, a ficin, a glucanase, an isomerase, a glutaminase, an invertase, a lactase, a lipase, a lyase, a lysozyme, a mannase, an oxidase, a pectinase, a peptidase, a peroxidase, a phospholipase, a protease, a trypsin, a urease, or combinations thereof.

In some embodiments, the anti-oxidant is an anti-oxidant vitamin, a tocopherol, a gallate or derivative thereof, or combinations thereof. In some embodiments, the anti-oxidant is 4-hexylresorcinol ascorbic acid or a fatty acid esters thereof, sodium ascorbate, calcium ascorbate, citric acid, erythorbic acid, sodium erythorbate, tertiary-butyl hydroquinone, butylated hydroxyanisole, butylated hydroxytoluene, or combinations thereof.

In some embodiments, the compositions further comprise a pH modifier. In some embodiments, the pH modifier is an acid. In some embodiments, the pH modifier is a base. The pH modifier can include, for example, citric acid, acetic acid, hydrochloric acid, sulfuric acid, phosphoric acid, hydrobromic acid, ascorbic acid, tartaric acid, formic acid, gluconic acid, lactic acid, oxalic acid, boric acid, or a combination thereof.

In some embodiments, the compositions further comprises a food-safe antimicrobial. In some embodiments, the food-safe antimicrobial comprises one or more of or is selected from the group consisting of sodium benzoate, potassium sorbate, carvacrol, chalcone, fludioxonil, 2-hydroxychalcone, 4-hydroxychalcone, 4′-hydroxychalcone, 2,2′-dihydroxychalcone, 2,4′-dihydroxychalcone, 2′,4-dihydroxychalcone, 2′,4′-dihydroxychalcone, 2′,4,4′-trihydroxychalcone, 2′,4,4′-trihydroxychalcone intermediate, violastyrene, obtusaquinone, apiole, piperine, celastrol, eugenol, arthonoic acid, leoidin, antimycin A, antimycin A1, diffractaic acid, ethyl orsellinate, methyl orsellinate, mycophenolic acid, ethyl dichloroorsellinate, angolensin, isocotoin, eupatoriochromene, xanthoxylin, usnic acid, aloin, ononetin, apocynin, isopomiferin, deoxysappanone B7,4′-dimethyl ether, chrysin dimethyl ether, bergapten, gambogic acid, 2-hydroxyxanthone, isopimpinellin, xanthyletin, acetyl hymetochrome, nobiletin, hymechrome, methoxsalen, 4-methylesculetin, tangeritin, khellin, flavone, 3,4′,5,6,7-pentamethoxyflavone, deguelin(-), citropten, deoxysappanone B trimethyl ether, deoxysappanone B 7,3′-dimethyl ether, 2′,4′-dihydroxy-4-methoxychalcone, daunorubicin hydrochloride, plumbagin, menadione, thymoquinone, levomenthol, thymol, methyl trimethoxycinnamate, chavicol, cinnamylphenol, benzoate, napthoquinone, phenone, acetophenone, benzophenone, phenylacetophenone, salicylic acid, sodium salicylate, methyl salicylate, or chitosan. In some embodiments, the one or more food-safe antimicrobials is benzoate. In some embodiments, the one or more food-safe antimicrobials is sodium benzoate, potassium benzoate, or a combination thereof. In some embodiments, the one or more food-safe antimicrobials is sodium benzoate. In some embodiments, the one or more food-safe antimicrobials is chalcone. In some embodiments, the antifungal comprises one or more of or is selected from the group consisting of imidazole, epicatechin, methyl salicylate (MeSA), and combinations thereof.

Agricultural Product Coated with a Barrier Film Composition

Also provided herein is an agricultural product having a coating of the any one of the barrier film compositions described herein on the surface of the agricultural product.

In some embodiments, the barrier film composition is applied to the agricultural product using any of the methods described herein.

In some embodiments, the agricultural product is a meat, a plant, a fungus, or a combination thereof. In some embodiments, the meat is derived from the group consisting of beef, lamb, poultry, pork, fish, shell-fish, boar, bison, deer, elk, camel, boar, rodent, and a combination thereof.

In some embodiments, the agricultural product is plant matter comprises one or more of or is selected from the group consisting of a fruit, a vegetable, a leaf, a stem, bark, a seed, a flower, a peel, a root, and a combination thereof. In some embodiments, the agricultural product is portioned.

In some embodiments, the barrier film composition is applied to the agricultural product pre-harvest. In some embodiments, the barrier film composition can be applied to the agricultural product after harvest (e.g., after the agricultural product has been separated from where the majority life has taken place). In some embodiments, the barrier film composition is applied to the agricultural product post-harvest.

Edible coatings (e.g., any of the barrier film compositions described herein) can comprise a biopolymer (e.g., polysaccharides) can be useful as packaging for agricultural products and processed foods (e.g., plant-based meat alternatives). In some cases, edible coatings comprising a biopolymer without other components can require refrigeration and/or additional packaging (i.e., plastic packaging) for preservation.

Provided herein are coated agricultural products. In some embodiments, a coating can be used as packaging of an agricultural product. In some embodiments, a coated agricultural product comprises an agricultural product having a surface, and a coating on the surface comprising a biopolymer; a monoglyceride, a fatty acid or salt thereof, and water.

In some embodiments, the biopolymer is combined with water and is applied as a first coating on the surface of the agricultural product. In some embodiments, the coating comprises the biopolymer at about a 0.5 M concentration to about a 5 M concentration. In some embodiments, the coating comprises the biopolymer at about a 1 M concentration to about a 5 M concentration, about a 1.5 M concentration to about a 5 M concentration, about a 2 M concentration to about a 5 M concentration, about a 2.5 M concentration to about a 5 M concentration, about a 3 M concentration to about a 5 M concentration, about a 3.5 M concentration to about a 5 M concentration, about a 4 M concentration to about a 5 M concentration, or about a 4.5 M concentration to about a 5 M concentration.

In some embodiments, the coating comprises the biopolymer at about 50 g/L to about 5000 g/L, at about 150 g/L to about 5000 g/L, at about 250 g/L to about 5000 g/L, at about 350 g/L to about 5000 g/L, at about 450 g/L to about 5000 g/L, at about 550 g/L to about 5000 g/L, at about 650 g/L to about 5000 g/L, at about 750 g/L to about 5000 g/L, at about 850 g/L to about 5000 g/L, at about 950 g/L to about 5000 g/L, at about 1050 g/L to about 5000 g/L, at about 1150 g/L to about 5000 g/L, at about 1250 g/L to about 5000 g/L, at about 1350 g/L to about 5000 g/L, at about 1450 g/L to about 5000 g/L, at about 1550 g/L to about 5000 g/L, at about 1650 g/L to about 5000 g/L, at about 1750 g/L to about 5000 g/L, at about 1850 g/L to about 5000 g/L, at about 1950 g/L to about 5000 g/L, at about 2050 g/L to about 5000 g/L, at about 2150 g/L to about 5000 g/L, at about 2250 g/L to about 5000 g/L, at about 2350 g/L to about 5000 g/L, at about 2450 g/L to about 5000 g/L, at about 2550 g/L to about 5000 g/L, at about 2650 g/L to about 5000 g/L, at about 2750 g/L to about 5000 g/L, at about 2850 g/L to about 5000 g/L, at about 2950 g/L to about 5000 g/L, at about 3050 g/L to about 5000 g/L, at about 3150 g/L to about 5000 g/L, at about 3250 g/L to about 5000 g/L, at about 3350 g/L to about 5000 g/L, at about 3450 g/L to about 5000 g/L, at about 3550 g/L to about 5000 g/L, at about 3650 g/L to about 5000 g/L, at about 3750 g/L to about 5000 g/L, at about 3850 g/L to about 5000 g/L, at about 3950 g/L to about 5000 g/L, at about 4050 g/L to about 5000 g/L, at about 4050 g/L to about 5000 g/L, at about 4150 g/L to about 5000 g/L, at about 4250 g/L to about 5000 g/L, at about 4350 g/L to about 5000 g/L, at about 4450 g/L to about 5000 g/L, at about 4550 g/L to about 5000 g/L, at about 4650 g/L to about 5000 g/L, at about 4750 g/L to about 5000 g/L, at about 4850 g/L to about 5000 g/L, or at about 4950 g/L to about 5000 g/L.

In some embodiments, the monoglyceride and the fatty acid or salt thereof are combined with water and applied as a second coating on the surface of the agricultural product coated with a first coating. In some embodiments, the monoglyceride and the fatty acid or salt thereof are combined with water and applied as a second coating over the first coating.

In some embodiments, the second coating comprises about 2 g/L to about 150 g/L of the monoglyceride. In some embodiments, the second coating comprises about 15 g/L of the monoglyceride to about 150 g/L of monoglyceride, about 25 g/L of the monoglyceride to about 150 g/L of monoglyceride, about 35 g/L of the monoglyceride to about 150 g/L of monoglyceride, about 45 g/L of the monoglyceride to about 150 g/L of monoglyceride, about 55 g/L of the monoglyceride to about 150 g/L of monoglyceride, about 65 g/L of the monoglyceride to about 150 g/L of monoglyceride, about 75 g/L of the monoglyceride to about 150 g/L of monoglyceride, about 85 g/L of the monoglyceride to about 150 g/L of monoglyceride, about 95 g/L of the monoglyceride to about 150 g/L of monoglyceride, about 105 g/L of the monoglyceride to about 150 g/L of monoglyceride, about 110 g/L of the monoglyceride to about 150 g/L of monoglyceride, about 125 g/L of the monoglyceride to about 150 g/L of monoglyceride, about 135 g/L of the monoglyceride to about 150 g/L of monoglyceride, or about 145 g/L of the monoglyceride to about 150 g/L of monoglyceride.

In some embodiments, the second coating comprises about 2 g/L of monoglyceride to about 50 g/L monoglyceride. In some embodiments, the second coating comprises about 5 g/L of the monoglyceride to about 50 g/L of monoglyceride, about 10 g/L of the monoglyceride to about 50 g/L of monoglyceride, about 15 g/L of the monoglyceride to about 50 g/L of monoglyceride, about 20 g/L of the monoglyceride to about 50 g/L of monoglyceride, about 25 g/L of the monoglyceride to about 50 g/L of monoglyceride, about 30 g/L of the monoglyceride to about 50 g/L of monoglyceride, about 35 g/L of the monoglyceride to about 50 g/L of monoglyceride, about 40 g/L of the monoglyceride to about 50 g/L of monoglyceride, or about 45 g/L of the monoglyceride to about 50 g/L of monoglyceride.

In some embodiments, the second coating comprises about 50 g/L of monoglyceride to about 125 g/L monoglyceride. In some embodiments, the second coating comprises about 60 g/L monoglyceride to about 125 g/L of monoglyceride, about 70 g/L monoglyceride to about 125 g/L of monoglyceride, about 80 g/L monoglyceride to about 125 g/L of monoglyceride, about 90 g/L monoglyceride to about 125 g/L of monoglyceride, about 100 g/L monoglyceride to about 125 g/L of monoglyceride, about 110 g/L monoglyceride to about 125 g/L of monoglyceride, or about 120 g/L monoglyceride to about 125 g/L of monoglyceride.

In some embodiments, the second coating comprises about 0.125 g/L fatty acid or salt to about 10 g/L fatty acid or salt. In some embodiments, the second coating comprises about 0.5 g/L fatty acid or salt to about 10 g/L fatty acid or salt, about 0.5 g/L fatty acid or salt to about 10 g/L fatty acid or salt, about 1.0 g/L fatty acid or salt to about 10 g/L fatty acid or salt, about 1.5 g/L fatty acid or salt to about 10 g/L fatty acid or salt, about 2.0 g/L fatty acid or salt to about 10 g/L fatty acid or salt, about 2.5 g/L fatty acid or salt to about 10 g/L fatty acid or salt, about 3.0 g/L fatty acid or salt to about 10 g/L fatty acid or salt, about 3.5 g/L fatty acid or salt to about 10 g/L fatty acid or salt, about 4.0 g/L fatty acid or salt to about 10 g/L fatty acid or salt, about 4.5 g/L fatty acid or salt to about 10 g/L fatty acid or salt, about 5.0 g/L fatty acid or salt to about 10 g/L fatty acid or salt, about 5.5 g/L fatty acid or salt to about 10 g/L fatty acid or salt, about 6.0 g/L fatty acid or salt to about 10 g/L fatty acid or salt, about 6.5 g/L fatty acid or salt to about 10 g/L fatty acid or salt, about 7.0 g/L fatty acid or salt to about 10 g/L fatty acid or salt, about 7.5 g/L fatty acid or salt to about 10 g/L fatty acid or salt, about 8.0 g/L fatty acid or salt to about 10 g/L fatty acid or salt, about 8.5 g/L fatty acid or salt to about 10 g/L fatty acid or salt, about 9.0 g/L fatty acid or salt to about 10 g/L fatty acid or salt, or about 9.5 g/L fatty acid or salt to about 10 g/L fatty acid or salt.

In some embodiments, the monoglyceride and the fatty acid or salt are combined. For example, the monoglyceride and the fatty acid or salt can be combined without the biopolymer. In some embodiments, the biopolymer is applied to the agricultural product prior to the mixture of the monoglyceride and the fatty acid or salt.

In some embodiments, a coated agricultural product comprises an agricultural product having a surface and a coating on the surface comprising about 1 M concentration of a biopolymer; a mixture of monoglyceride and a fatty acid or salt at about 80% w/w monoglyceride and 20% w/w fatty acid or salt; and water.

In some embodiments, a coated agricultural product comprises an agricultural product having a surface and a coating on the surface comprising about 1 M concentration of a biopolymer; a mixture of a saturated monoglyceride and a fatty acid or salt; at about 80% w/w saturated monoglyceride and 20% w/w fatty acid or salt; and water.

In some embodiments, a coated agricultural product comprises an agricultural product having a surface and a coating on the surface comprising about 1 M concentration of a biopolymer; a mixture of saturated monoglyceride and a saturated fatty acid or salt at about 80% w/w saturated monoglyceride and 20% w/w saturated fatty acid or salt; and water.

In some embodiments, a coated agricultural product comprises an agricultural product having a surface and a coating on the surface comprising about 1 M concentration of a biopolymer; a mixture of a saturated monoglyceride and a fatty acid or salt at about 90% w/w monoglyceride and 10% w/w fatty acid or salt; and water.

In some embodiments, a coated agricultural product comprises an agricultural product having a surface and a coating on the surface comprising; about 1 M concentration of a biopolymer; a mixture of a saturated monoglyceride and a fatty acid or salt at about 90% w/w saturated monoglyceride and 10% w/w fatty acid or salt; and water.

In some embodiments, a coated agricultural product comprises an agricultural product having a surface and a coating on the surface comprising about 1 M concentration of a biopolymer; a mixture of saturated monoglyceride and a saturated fatty acid or salt at about 90% w/w saturated monoglyceride and 10% w/w saturated fatty acid or salt; and water.

In some embodiments, a coated agricultural product comprises an agricultural product having a surface and a coating on the surface comprising about 1 M concentration of a biopolymer; a mixture of saturated monoglyceride and a fatty acid or salt at about 95% w/w monoglyceride and 5% w/w fatty acid or salt; and water.

In some embodiments, a coated agricultural product comprises an agricultural product having a surface and a coating on the surface comprising about 1 M concentration of a biopolymer; a mixture of saturated monoglyceride and a saturated fatty acid or salt at about 95% w/w saturated monoglyceride and 5% w/w saturated fatty acid or salt; and water.

In some embodiments, a coated agricultural product comprises an agricultural product having a surface and a coating on the surface comprising about 1 M concentration of a biopolymer; a mixture of monoglyceride and a fatty acid or salt at about 96% w/w monoglyceride and 4% w/w fatty acid or salt; and water.

In some embodiments, a coated agricultural product comprises an agricultural product having a surface and a coating on the surface comprising about 1 M concentration of a biopolymer; a mixture of a saturated monoglyceride and a fatty acid or salt at about 96% w/w saturated monoglyceride and 4% w/w fatty acid or salt; and water.

In some embodiments, the fatty acid or salt is a saturated fatty acid or salt. In some embodiments, a coated agricultural product comprises an agricultural product having a surface and a coating on the surface comprising about 1 M concentration of a biopolymer; a mixture of saturated monoglyceride and a saturated fatty acid or salt at about 96% w/w saturated monoglyceride and 4% w/w saturated fatty acid or salt; and water.

In some embodiments, a coated agricultural product comprises an agricultural product having a surface and a coating on the surface comprising about 1 M concentration of a polysaccharide; a mixture of about 70% w/w of a C10 saturated monoglyceride, a C12 saturated monoglyceride, a C14 saturated monoglyceride, a C16 saturated monoglyceride, a C18 saturated monoglyceride, a C20 saturated monoglyceride, and a combination thereof, and about 30% w/w of a fatty acid or salt; and water.

In some embodiments, the fatty acid or salt is a saturated fatty acid or salt. In some embodiments, a coated agricultural product comprises an agricultural product having a surface and a coating on the surface comprising about 1 M concentration of a polysaccharide; a mixture of about 70% w/w a C10 saturated monoglyceride, a C12 saturated monoglyceride, a C14 saturated monoglyceride, a C16 saturated monoglyceride, a C18 saturated monoglyceride, a C20 saturated monoglyceride, and a combination thereof and 30% w/w saturated fatty acid or salt; and water.

In some embodiments, a coated agricultural product comprises an agricultural product having a surface and a coating on the surface comprising about 1 M concentration of a polysaccharide; a mixture of about 80% w/w of a C10 saturated monoglyceride, a C12 saturated monoglyceride, a C14 saturated monoglyceride, a C16 saturated monoglyceride, a C18 saturated monoglyceride, a C20 saturated monoglyceride, and a combination thereof and 20% w/w fatty acid or salt; and water.

In some embodiments, the fatty acid or salt is a saturated fatty acid or salt. In some embodiments, a coated agricultural product comprises an agricultural product having a surface and a coating on the surface comprising about 1 M concentration of a polysaccharide; a mixture of about 80% w/w a C10 saturated monoglyceride, a C12 saturated monoglyceride, a C14 saturated monoglyceride, a C16 saturated monoglyceride, a C18 saturated monoglyceride, a C20 saturated monoglyceride, and a combination thereof and 20% w/w saturated fatty acid or salt; and water.

In some embodiments, a coated agricultural product comprises an agricultural product having a surface and a coating on the surface comprising about 1 M concentration of a polysaccharide; a mixture of about 90% w/w a C10 saturated monoglyceride, a C12 saturated monoglyceride, a C14 saturated monoglyceride, a C16 saturated monoglyceride, a C18 saturated monoglyceride, a C20 saturated monoglyceride, and a combination thereof and 10% w/w fatty acid or salt; and water.

In some embodiments, the fatty acid or salt is a saturated fatty acid or salt. In some embodiments, a coated agricultural product comprises an agricultural product having a surface and a coating on the surface comprising about 1 M concentration of a polysaccharide; a mixture of about 90% w/w of a C10 saturated monoglyceride, a C12 saturated monoglyceride, a C14 saturated monoglyceride, a C16 saturated monoglyceride, a C18 saturated monoglyceride, a C20 saturated monoglyceride, and a combination thereof and about 10% w/w of a saturated fatty acid or salt; and water.

In some embodiments, a coated agricultural product comprises an agricultural product having a surface and a coating on the surface comprising about 1 M concentration of the polysaccharide; a mixture of about 95% w/w a C10 saturated monoglyceride, a C12 saturated monoglyceride, a C14 saturated monoglyceride, a C16 saturated monoglyceride, a C18 saturated monoglyceride, a C20 saturated monoglyceride, and a combination thereof and 5% w/w fatty acid or salt; and water.

In some embodiments, the fatty acid or salt is a saturated fatty acid or salt. In some embodiments, a coated agricultural product comprises an agricultural product having a surface and a coating on the surface comprising about 1 M concentration of a polysaccharide; a mixture of about 95% w/w a C10 saturated monoglyceride, a C12 saturated monoglyceride, a C14 saturated monoglyceride, a C16 saturated monoglyceride, a C18 saturated monoglyceride, a C20 saturated monoglyceride, and a combination thereof and 5% w/w saturated fatty acid or salt; and water.

In some embodiments, a coated agricultural product comprises an agricultural product having a surface and a coating on the surface comprising about 1 M concentration of a polysaccharide; a mixture of about 96% w/w a C10 saturated monoglyceride, a C12 saturated monoglyceride, a C14 saturated monoglyceride, a C16 saturated monoglyceride, a C18 saturated monoglyceride, a C20 saturated monoglyceride, and a combination thereof and 4% w/w fatty acid or salt; and water.

In some embodiments, the fatty acid or salt is a saturated fatty acid or salt. In some embodiments, a coated agricultural product comprises an agricultural product having a surface and a coating on the surface comprising about 1 M concentration of a polysaccharide; a mixture of 96% w/w of a C10 saturated monoglyceride, a C12 saturated monoglyceride, a C14 saturated monoglyceride, a C16 saturated monoglyceride, a C18 saturated monoglyceride, a C20 saturated monoglyceride, and combination thereof and about 4% w/w of a saturated fatty acid or salt; and water.

In some embodiments, a coated agricultural product comprises an agricultural product having a surface and a coating on the surface comprising about 1 M concentration of xanthan gum, guar gum, pectin, gum arabic, carrageenan, potassium alginate, ammonium alginate, calcium alginate, sodium alginate, agar, cellulose, starch, or chitosan, and a combination thereof; a mixture of about 70% w/w monolaurin, glyceryl monostearate, glycerol monostearate, or glyceryl hydroxystearate and 30% w/w sodium laurate, myristate, sodium palmitate, sodium stearate, or sodium behenate; and water.

In some embodiments, a coated agricultural product comprises an agricultural product having a surface and a coating on the surface comprising about 1 M concentration of xanthan gum, guar gum, pectin, gum arabic, carrageenan, potassium alginate, ammonium alginate, calcium alginate, sodium alginate, agar, cellulose, starch, or chitosan, and a combination thereof; a mixture of about 80% w/w monolaurin, glyceryl monostearate, glycerol monostearate, or glyceryl hydroxystearate and 20% w/w sodium laurate, myristate, sodium palmitate, sodium stearate, or sodium behenate; and water.

In some embodiments, a coated agricultural product comprises an agricultural product having a surface and a coating on the surface comprising about 1 M concentration of xanthan gum, guar gum, pectin, gum arabic, carrageenan, potassium alginate, ammonium alginate, calcium alginate, sodium alginate, agar, cellulose, starch, or chitosan, and a combination thereof; a mixture of about 90% w/w monolaurin, glyceryl monostearate, glycerol monostearate, or glyceryl hydroxystearate and 10% w/w sodium laurate, myristate, sodium palmitate, sodium stearate, or sodium behenate; and water.

In some embodiments, a coated agricultural product comprises an agricultural product having a surface and a coating on the surface comprising about 1 M concentration of xanthan gum, guar gum, pectin, gum arabic, carrageenan, potassium alginate, ammonium alginate, calcium alginate, sodium alginate, agar, cellulose, starch, or chitosan, and a combination thereof; a mixture of about 95% w/w monolaurin, glyceryl monostearate, glycerol monostearate, or glyceryl hydroxystearate and 5% w/w sodium laurate, myristate, sodium palmitate, sodium stearate, or sodium behenate; and water.

In some embodiments, a coated agricultural product comprises an agricultural product having a surface and a coating on the surface comprising about 1 M concentration of xanthan gum, guar gum, pectin, gum arabic, carrageenan, potassium alginate, ammonium alginate, calcium alginate, sodium alginate, agar, cellulose, starch, or chitosan, and a combination thereof; a mixture of about 96% w/w monolaurin, glyceryl monostearate, glycerol monostearate, or glyceryl hydroxystearate and 4% w/w sodium laurate, myristate, sodium palmitate, sodium stearate, or sodium behenate; and water.

In some embodiments, a coated agricultural product comprises an agricultural product having a surface and a coating on the surface comprising about 1 M concentration of calcium alginate; a mixture of about 70% w/w glyceryl monostearate and 30% w/w sodium stearate; and water.

In some embodiments, a coated agricultural product comprises an agricultural product having a surface and a coating on the surface comprising about 1 M concentration of calcium alginate; a mixture of about 80% w/ glyceryl monostearate and 20% w/w sodium stearate; and water.

In some embodiments, a coated agricultural product comprises an agricultural product having a surface and a coating on the surface comprising about 1 M concentration of calcium alginate; a mixture of about 90% w/w glyceryl monostearate and 10% w/w sodium stearate; and water.

In some embodiments, a coated agricultural product comprises an agricultural product having a surface and a coating on the surface comprising about 1 M concentration of calcium alginate; a mixture of about 95% w/w glyceryl monostearate and 5% w/w sodium stearate; and water.

In some embodiments, a coated agricultural product comprises an agricultural product having a surface and a coating on the surface comprising about 1 M concentration of calcium alginate; a mixture of about 96% w/w glyceryl monostearate and 4% w/w sodium stearate; and water.

In some embodiments, a coated agricultural product comprises an agricultural product having a surface and a coating on the surface comprising about 1 M concentration of sodium alginate; a mixture of about 70% w/w glyceryl monostearate and 30% w/w sodium stearate; and water.

In some embodiments, a coated agricultural product comprises an agricultural product having a surface and a coating on the surface comprising about 1 M concentration of sodium alginate; a mixture of about 80% w/ glyceryl monostearate and 20% w/w sodium stearate; and water.

In some embodiments, a coated agricultural product comprises an agricultural product having a surface and a coating on the surface comprising about 1 M concentration of sodium alginate; a mixture of about 90% w/w glyceryl monostearate and 10% w/w sodium stearate; and water.

In some embodiments, a coated agricultural product comprises an agricultural product having a surface and a coating on the surface comprising about 1 M concentration of sodium alginate; a mixture of about 95% w/w glyceryl monostearate and 5% w/w sodium stearate; and water.

In some embodiments, a coated agricultural product comprises an agricultural product having a surface and a coating on the surface comprising about 1 M concentration of sodium alginate; a mixture of about 96% w/w glyceryl monostearate and 4% w/w sodium stearate; and water.

In some embodiments, a coated agricultural product comprises an agricultural product having a surface and a coating on the surface comprising about 1 M concentration of cellulose; a mixture of about 70% w/w glyceryl monostearate and 30% w/w sodium stearate; and water.

In some embodiments, a coated agricultural product comprises an agricultural product having a surface and a coating on the surface comprising about 1 M concentration of cellulose; a mixture of about 80% w/ glyceryl monostearate and 20% w/w sodium stearate; and water.

In some embodiments, a coated agricultural product comprises an agricultural product having a surface and a coating on the surface comprising about 1 M concentration of cellulose; a mixture of about 90% w/w glyceryl monostearate and 10% w/w sodium stearate; and water.

In some embodiments, a coated agricultural product comprises an agricultural product having a surface and a coating on the surface comprising about 1 M concentration of cellulose; a mixture of about 95% w/w glyceryl monostearate and 5% w/w sodium stearate; and water.

In some embodiments, a coated agricultural product comprises an agricultural product having a surface and a coating on the surface comprising about 1 M concentration of cellulose; a mixture of about 96% w/w glyceryl monostearate and 4% w/w sodium stearate; and water.

In some embodiments, a coated agricultural product comprises an agricultural product having a surface and a coating on the surface comprising about 1 M concentration of chitosan; a mixture of about 70% w/w glyceryl monostearate and 30% w/w sodium stearate; and water.

In some embodiments, a coated agricultural product comprises an agricultural product having a surface and a coating on the surface comprising about 1 M concentration of chitosan; a mixture of about 80% w/ glyceryl monostearate and 20% w/w sodium stearate; and water.

In some embodiments, a coated agricultural product comprises an agricultural product having a surface and a coating on the surface comprising about 1 M concentration of chitosan; a mixture of about 90% w/w glyceryl monostearate and 10% w/w sodium stearate; and water.

In some embodiments, a coated agricultural product comprises an agricultural product having a surface and a coating on the surface comprising about 1 M concentration of chitosan; a mixture of about 95% w/w glyceryl monostearate and 5% w/w sodium stearate; and water.

In some embodiments, a coated agricultural product comprises an agricultural product having a surface and a coating on the surface comprising about 1 M concentration of chitosan; a mixture of about 96% w/w glyceryl monostearate and 4% w/w sodium stearate; and water.

In some embodiments, a surfactant is an anionic surfactant. In some embodiments, the anionic surfactant comprises one or more of or is selected from the group consisting of sodium decyl sulfate, sodium N-lauroyl-N-methyltaurate, sodium tetradecyl sulfate, sodium dodecyl sulfate, and a combination thereof.

In some embodiments, the coated agricultural product is a meat, a plant, a fungus, or a combination thereof. In some embodiments, the meat is derived from the group consisting of beef, lamb, poultry, pork, fish, shell-fish, boar, bison, deer, elk, camel, boar, rodent, and a combination thereof.

In some embodiments, the coated agricultural product is plant matter that comprises one or more of or is selected from the group consisting of a fruit, a vegetable, a leaf, a stem, bark, a seed, a flower, a peel, a root, and a combination thereof. In some embodiments, the agricultural product is portioned. In some embodiments, the plant matter is a fruit. In some embodiments, the plant matter is a vegetable. In some embodiments, the plant matter is a flower.

In some embodiments, the coating of the coated agricultural product is applied pre-harvest. In some embodiments, the coating of the coated agricultural product can be applied to the agricultural product after harvest (e.g., after the agricultural product has been separated from where the majority life has taken place). In some embodiments, the coating of the coated agricultural product is applied to the agricultural product post-harvest. In some embodiments, the coated agricultural product has been portioned prior to the application of the coating.

### Methods

Also provided herein are methods of coating plant matter and/or agricultural products, the method comprising providing a barrier film composition as described in any of the embodiments described herein and applying the barrier film composition onto a surface of the plant matter.

Also provided herein, is another method of coating an agricultural product, the method comprising providing a first coating comprising a biopolymer and water; applying the first coating onto a surface of the agricultural product; providing a second coating comprising a monoglyceride, a fatty acid salt, and water; and applying the second coating to the surface of agricultural product over the first coating. In some embodiments, the biopolymer is calcium alginate. In some embodiments, prior to applying the first coating onto a surface of the agricultural product, the calcium alginate is crosslinked.

In some embodiments, the method further comprises blending (e.g., homogenizing) the barrier film composition, the first coating, and/or the second coating with the water. In some embodiments, the barrier film compositions, the first coating, and/or the second coating described herein are homogenized with water prior to the application to the plant matter and/or agricultural product. In some embodiments, the water is deionized water. In some embodiments, the water is heated. In some embodiments, the water is heated to a temperature of about 60° C. to about 100° C. In some embodiments, the water is heated to about 70° C. to about 100° C., about 80° C. to about 100° C., or about 90° C. to about 100° C. about. In some embodiments, the water is heated to about 90° C. to about 110° C. or about 100° C. to about 110° C. about. In some embodiments, the water is heated to about 80° C. In some embodiments, the water is heated to about 90° C.

In some embodiments, the method includes blending (e.g., homogenizing) the barrier film composition, the first coating, and/or the second coating, with the water for a period of time. In some embodiments, any of the barrier film compositions described herein, the first coating, and/or the second coating, are homogenized using any suitable method of homogenization. Commercially available homogenizing devices can be used to homogenize the barrier film composition, the first coating, and/or the second coating. In some embodiments, the barrier film composition, the first coating, and/or the second coating is homogenized using a blender. In some embodiments, the method further comprises homogenizing the composition prior to applying the barrier film composition, the first coating, and/or the second coating to the plant matter. In some embodiments, the period of time is about 1 minute to about 15 minutes, about 2 minutes to about 15 minutes, about 3 minutes to about 15 minutes, about 4 minutes to about 15 minutes, about 5 minutes to about 15 minutes, about 6 minutes to about 15 minutes, about 7 minutes to about 15 minutes, about 8 minutes to about 15 minutes, about 9 minutes to about 15 minutes, about 10 minutes to about 15 minutes, about 11 minutes to about 15 minutes, about 12 minutes to about 15 minutes, about 13 minutes to about 15 minutes, or about 14 minutes to about 15 minutes.

Any of the barrier film compositions, the first coating, and/or the second coating can be disposed on the external surface of plant matter (e.g., agricultural product) using any suitable means. In some embodiments, the plant matter and/or agricultural product can be dip coated in a bath of the barrier film composition, the first coating, and/or the second coating. In some embodiments, applying the barrier film composition to the plant matter and/or agricultural product comprises dipping the plant matter in the barrier film composition, the first coating, and/or the second coating. The barrier film composition, the first coating, and/or the second coating can form a thin layer on the surface of plant matter, which can protect the plant matter from biotic stressors, water loss, and/or oxidation.

In some embodiments, any of the barrier film compositions described herein, the first coating, and/or the second coating can be spray coated on the plant matter and/or agricultural product. In some embodiments, applying the composition to the surface of the plant matter comprises spraying the barrier film composition, the first coating, and/or the second coating on the surface of the plant matter. Commercially available sprayers can be used for spraying the barrier film composition, the first coating, and/or the second coating onto the surface of the plant matter.

In some embodiments, the method can further include allowing the barrier film composition, the first coating, and/or the second coating to at least partially evaporate (e.g., dry) for a period of time of about 30 seconds to about 180 seconds after applying barrier film composition, the first coating, and/or the second coating to the plant matter (e.g., the agricultural product). In some embodiments, the period of time is about 40 seconds to about 180 seconds, about 50 seconds to about 180 seconds, about 60 seconds to about 180 seconds, about 70 seconds to about 180 seconds, about 80 seconds to about 180 seconds, about 90 seconds to about 180 seconds, about 100 seconds to about 180 seconds, about 110 seconds to about 120 seconds, about 140 seconds to about 180 seconds, about 150 seconds to about 180 seconds, about 160 seconds to about 180 seconds, or about 170 seconds to about 180 seconds. In some embodiments, the period of time is about 60 seconds to about 120 seconds, about 70 seconds to about 120 seconds, about 80 seconds to about 120 seconds, about 90 seconds to about 120 seconds, about 100 seconds to about 120 seconds, or about 110 seconds.

In some embodiments, the method further comprises allowing the barrier film composition, the first coating, and/or the second coating to at least partially evaporate for a period time of about 90 seconds after applying to the plant matter. In some embodiments, the method further comprises allowing the barrier film composition, the first coating, and/or the second coating to at least partially evaporate for a period time of about 100 seconds after applying to the plant matter. In some embodiments, the method further comprises allowing the barrier film composition, the first coating, and/or the second coating to at least partially evaporate for a period time of about 110 seconds after applying to the plant matter.

In some embodiments, the method can further include allowing the barrier film composition, the first coating, and/or the second coating to at least partially evaporate (e.g., dry) for a period of time of about 40 minutes to about 80 minutes after applying barrier film composition, the first coating, and/or the second coating to the plant matter (e.g., the agricultural product). In some embodiments, the period of time is about 45 minutes to about 80 minutes, about 50 minutes to about 80 minutes, about 55 minutes to about 80 minutes, about 60 minutes to about 80 minutes, about 65 minutes to about 80 minutes, about 70 minutes to about 80 minutes, or about 75 minutes to about 80 minutes. In some embodiments, the method further comprises allowing the first coating to dry for a period of time prior to applying the second coating to the surface of agricultural product over the first coating.

In some embodiments, the deposited barrier film composition, the first coating, and/or the second coating can have a thickness of less than about 2 microns, for example less than 1 micron, less than 900 nm, less than 800 nm, less than 700 nm, less than 600 nm, less than 500 nm, less than 400 nm, less than 300 nm, less than 200 nm, or less than 100 nm, such that the barrier film composition is transparent to the naked eye. For example, the deposited barrier film composition can have a thickness of about 50 nm, 60 nm, 70 nm, 80 nm, 90 nm, 100 nm, 110 nm, 120 nm, 130 nm, 140 nm, 150 nm, 200 nm, 250 nm, 300 nm, 350 nm, 400 nm, 450 nm, 500 nm, 600 nm, 700 nm, 800 nm, 900 nm, or about 1,000 nm inclusive of all ranges therebetween.

The deposited barrier film composition, the first coating, and/or the second coating can have a high degree of crystallinity to decrease permeability, such that the barrier film composition, the first coating, and/or the second coating is conformally deposited over the plant matter and is free of defects and/or pinholes. In some embodiments, applying the barrier film composition, the first coating, and/or the second coating to the plant matter comprises dipping the plant matter in the barrier film composition.

In some embodiments, the barrier film composition, the first coating, and/or the second coating can be deposited on an agricultural product such as plant matter by passing the agricultural products under a stream of the barrier film composition, the first coating, and/or the second coating (e.g., a waterfall of the barrier film composition, the first coating and/or the second coating). For example, the plant matter can be disposed on a conveyor that passes through the stream of the barrier film composition, the first coating, and/or the second coating. In some embodiments, the barrier film composition, the first coating, and/or the second coating can be vapor deposited on the surface of the plant matter. In some embodiments, the barrier film composition, the first coating, and/or the second coating can be applied in the field before harvest. In some embodiments, the barrier film composition, the first coating, and/or the second coating is applied to the plant matter pre-harvest. In some embodiments, the barrier film composition can be applied to the plant matter after harvest (e.g., after the plant matter has been separated from where the majority of growth has taken place). In some embodiments, the barrier film composition, the first coating, and/or the second coating is applied to the plant matter post-harvest.

In some embodiments, the plant matter is an agricultural product such as a flower or produce (e.g., fresh produce). In some embodiments, the plant matter comprises one or more of or is selected from the group consisting of a fruit, a vegetable, a leaf, a stem, bark, a seed, a flower, and a combination thereof. In some embodiments, the plant matter is a flower. In some embodiments, the plant matter is fresh produce. In some embodiments, the plant matter is a vegetable. In some embodiments, the plant matter is a fruit.

In some embodiments, following the application of the barrier film composition, the first coating, and/or the second coating to the plant matter desiccation is reduced. In some embodiments, following application of the barrier film composition, the first coating, and/or the second coating the rate of water lost from the plant matter is reduced. In some embodiments, desiccation is measured with mass loss. In some embodiments, following the application of the barrier film composition, the first coating, and/or the second coating the rate of mass loss is reduced. In some embodiments, water loss is measured by mass loss. Mass loss, for example, can be measured by determining the difference between the weight of plant matter after application of the barrier film composition and after a certain period of time passes. In some embodiments, mass loss is measured after 1 day, 2 days, 3 days, 4 days, 5 days, 6 days, 7, days, 8 days, 9 days, and/or 10 days or after any combination thereof. In some embodiments, mass loss is measured after 1 week, after 2 weeks, after 3 weeks, after 4 weeks, after 5 weeks, after 6 weeks, after 7 weeks, after 8 weeks, after 9 weeks, after 10 weeks, after 11 weeks, after 12 weeks, or after any combination thereof.

In some embodiments, following application of the barrier film composition, the first coating, and/or the second coating the respiration rate of the plant matter can be reduced. For example, the application of any of the barrier film compositions, the first coating, and/or the second coating described herein can be used to block or limit diffusion of gasses such as ethylene, CO₂, and 02, among others, thereby slowing ripening and/or senescence. In some embodiments, following the application of the composition, the rate of CO₂ production by the plant matter is reduced.

### EXAMPLES

The materials and methods of the disclosure will be further described in the following examples, which do not limit the scope of the methods and compositions of matter described in the claims.

### Example 1

This example demonstrates the viscoelastic behavior of mixtures of monoglyceride and fatty acid or a salt thereof with xanthan gum in deionized distilled water.

A dispersion of monoglyceride and fatty acid or a salt thereof was prepared by adding 30 grams of a mixture of 94% w/w glyceryl monostearate and 6% w/w sodium stearate to 1000 mL of deionized distilled water that had been heated to 80° C. The mixture was blended for 3 minutes at maximum speed (10,200 rpm) in a SILVERSON® L5M-A blender and then cooled to room temperature. The dispersion was stable after keeping on the bench overnight and was used for additional sample preparation.

A solution of xanthan gum (KELTROL® from CP KELCO) in deionized distilled water was prepared by adding 4 grams of xanthan gum to 1000 mL of water and stirring overnight using a magnetic stirrer. The solution was used for additional sample preparation.

The above samples were combined to prepare the following additional samples.

### Sample A

15 g/L (of the mixture of 94% w/w glyceryl monostearate and 6% w/w sodium stearate) in deionized distilled water with 0.2% xanthan gum w/v.

### Sample B

15 g/L (of the mixture of 94% w/w glyceryl monostearate and 6% w/w sodium stearate) in deionized distilled water with 0.15% xanthan gum w/v.
Sample C (control)
15 g/L (of the mixture of 94% w/w glyceryl monostearate and 6% w/w sodium stearate) in deionized distilled water with 0.1% xanthan gum w/v.
Sample D (control)
10 g/L (of the mixture of 94% w/w glyceryl monostearate and 6% w/w sodium stearate) in deionized distilled water with 0.1% xanthan gum w/v.
Sample E (control)
15 g/L (of the mixture of 94% w/w glyceryl monostearate and 6% w/w sodium stearate) in deionized distilled water.
Sample F (control)
10 g/L (of the mixture of 94% w/w glyceryl monostearate and 6% w/w sodium stearate) in deionized distilled water.
The viscoelastic response of samples A-F at 25° C. was determined using a DHR-3 rheometer from TA INSTRUMENTS™ with double concentric cylinder measuring geometry. The elastic (G′) and viscous (G″) modulus of each of the samples was measured as a function of the oscillatory stress amplitude at a frequency of 1 Hz and the crossover of G′ and G″ was noted as the yield stress.

TABLE 1
Yield stress of tested samples

| SAMPLE | YIELD STRESS at 1 Hz (Pa) |
|---|---|
| A | 1.1 |
| B | 0.5 |
| C (control) | 0 |
| D (control) | 0 |
| E (control) | 0 |
| F (control) | 0 |

A yield stress was detected for samples A and B but not for samples C, D, E and F.

### Example 2

This example illustrates the effect of yield stress on coating and barrier properties of the formulation on fresh produce.

2 L batches of samples A, B and E (See example 1) were prepared. Avocados were dip-coated in these samples and then dried in a rolling, translating heat tunnel at 65-70° C. for 100 seconds. 90 avocados of the same size, quality, ripeness, pack date and orchard were used in each group.

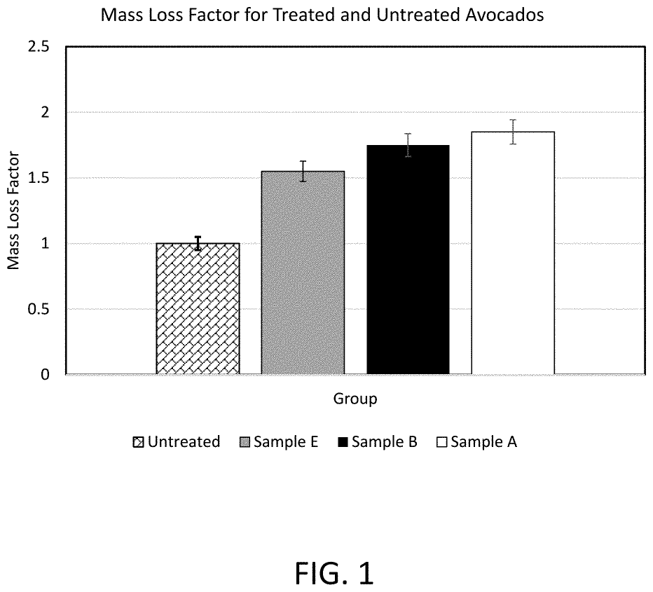

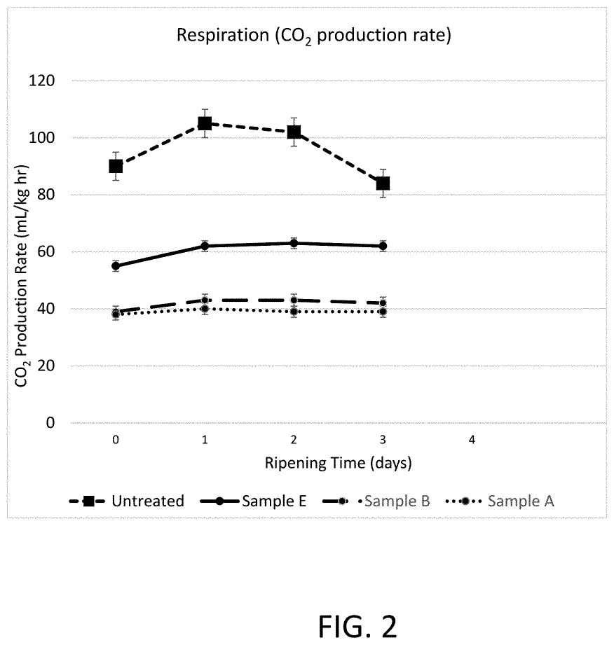

Mass loss and respiration were measured for the treated fruits and compared with untreated fruits. The results are shown in FIG. 1 and FIG. 2. In FIG. 1 Mass loss factor for treated (samples A and B) and control (sample E) avocados. Mass loss factor was determined by dividing the mass loss rate of the untreated control by the respective treatment values.

FIG. 2. Respiration rate versus time for treated (sample A and B) and control avocados. It is clear that the methods herein provide significant improvement in barrier properties in terms of mass loss and respiration. Fruit treated with samples A and B show a much higher mass loss factor and lower respiration rate compared to sample E (control).

### Example 3

This example also illustrates the effect of yield stress on coating and barrier properties of the formulation on fresh produce.

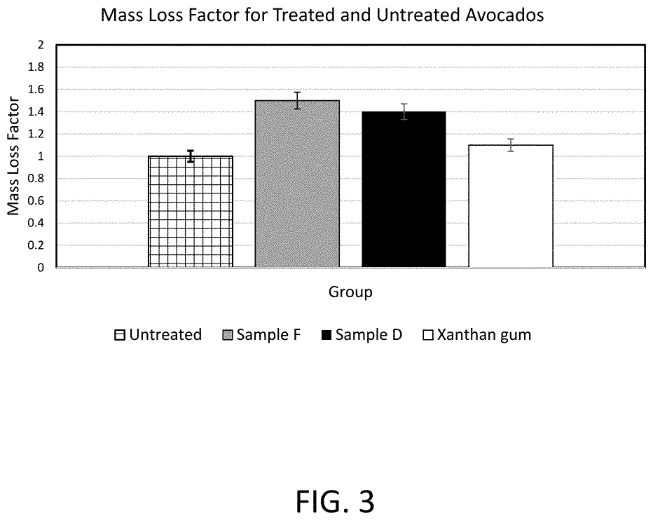

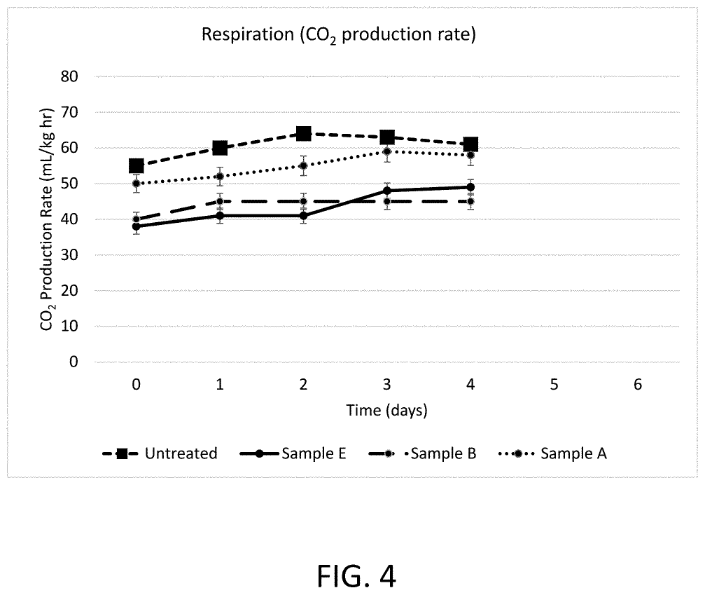

2 L batches of samples D and F (controls-see example 1) were prepared. A 2 L batch of an additional control containing 0.2% xanthan gum in water but without anything else was also prepared. Avocados were dip-coated in these samples and then dried in a rolling, translating heat tunnel at 65-70° C. for 100 seconds. 90 avocados of the same size, quality, ripeness, pack date and orchard were used in each group. Mass loss and respiration were measured for the treated fruits and compared with untreated fruits. The results are shown in FIG. 3 and FIG. 4. FIG. 3 Mass loss factor for treated (samples D and F and additional control 0.2% xanthan gum (KELTROL®)) and untreated avocados. FIG. 4 Respiration rate versus time for treated (samples D and F and 0.2%))(KELTROL® and untreated avocados.

It is clear that mixtures of monoglyceride and a fatty acid or a salt thereof and rheology modifier without a yield stress and rheology modifier alone do not provide the substantial benefit in barrier properties compared to compositions without rheology modifier (control sample F).

### Example 4

This example illustrates the properties of yield stress with shear thinning in mixtures of monoglyceride and fatty acid or salt thereof with xanthan gum in deionized distilled water.

A dispersion of monoglyceride and fatty acid or salt thereof was prepared by adding 50 grams of a mixture of 94% w/w glyceryl monostearate and 6% w/w sodium stearate to 1000 mL of deionized distilled water that had been heated to 80° C. The mixture was blended for 3 minutes at maximum speed (10,200 rpm) in a SILVERSON® L5M-A blender and then cooled to room temperature. The dispersion was stable after keeping on the bench overnight and was used for additional sample preparation.

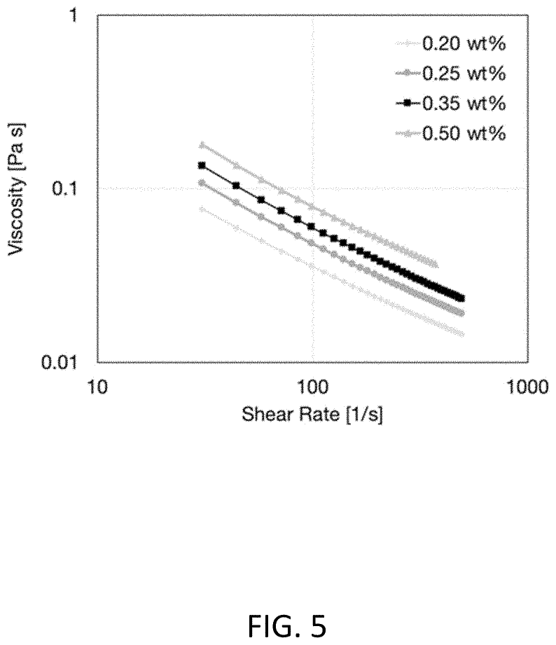

This dispersion was then combined with a solution of xanthan gum in deionized distilled water to prepare a series of samples containing 25 g/L (of the mixture of 94% w/w glyceryl monostearate and 6% w/w sodium stearate) and different concentrations of xanthan gum ranging from 0.2% to 0.5% w/v. The viscosity of these samples as a function of shear rate at 25° C. in the shear rate range of 50 to 500 s⁻¹ was determined using a DHR-3 rheometer from TA INSTRUMENTS™ with double concentric cylinder measuring geometry. The results of these measurements are shown in FIG. 5. The curves in FIG. 5 were fitted using the Carreau equation to estimate the viscosity at a shear rate of 5000 s⁻¹ which is an estimated shear rate at the point of application of formulation to the surface of produce in a roller application. The yield stress of these samples was also measured in the same manner as described in Example 1.

TABLE 2
Yield stress of samples with different
concentrations of xanthan gum

| Concentration of | Estimated viscosity at 5000 | |
|---|---|---|
| xanthan gum | s⁻¹ (Pa · s) | Yield stress (Pa) |
| 0.2% w/v | 0.006 | 1.23 |
| 0.25% w/v | 0.008 | 2.30 |
| 0.35% w/v | 0.01 | 3.88 |
| 0.5% w/v | 0.014 | 4.78 |

Table 2 shows that these compositions have the combination of yield stress with a low viscosity at the point of application (less than 0.05 Pa. s) that is desirable.

### Example 5

This example illustrates barrier film properties and rheology of a mixture of monoglyceride, a longer chain fatty acid or salt thereof, a shorter chain fatty acid or salt thereof and the rheology modifier xanthan gum in deionized distilled water. In this case the longer chain fatty acid or salt thereof functions as an emulsifier for the monoglyceride whereas the shorter chain fatty acid or a salt thereof functions as a wetting agent to facilitate spreading of the formulation on the surface of the produce.

Samples with the following compositions were prepared by the methods outlined in examples 1-4.

TABLE 3
Barrier film compositions tested

| | Glyceryl | | | |
|---|---|---|---|---|
| | Monostearate | Sodium | Sodium | Xanthan Gum |
| Sample | (g/L) | Stearate (g/L) | Laurate (g/L) | % w/v |
| G | 23.75 | 1.25 | 0 | 0 |
| H | 23.75 | 1.25 | 0 | 0.2 |
| J | 23.75 | 1.25 | 1.5 | 0 |
| K | 23.75 | 1.25 | 1.5 | 0.2 |

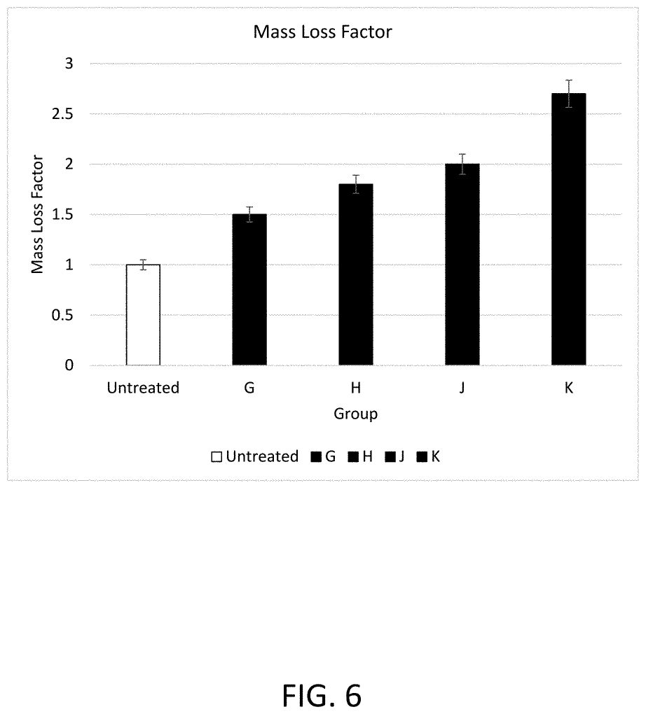

Avocados were dip coated in these samples and dried in the same manner as described in example 2. Mass loss was measured for the treated fruits and compared with untreated fruits. The results are shown in FIG. 6.

The mass loss factor of fruits treated with compositions containing monoglyceride and emulsifier with either rheology modifier or wetting agent (samples H and J) is higher compared to that of fruits treated with a composition that contains monoglyceride and emulsifier but without these additives (sample G). However, significantly higher mass loss factor (indicating more effective moisture barrier properties) is observed for compositions of monoglyceride and emulsifier that contain in addition both wetting agent and rheology modifier (sample K).

The yield stress of samples H and K were determined as described in Example 1.

TABLE 4
Yield stress of samples H and K

| Sample | Yield Stress (Pa) |
|---|---|
| H | 1.36 |
| K | 1.53 |

It is observed that addition of the wetting agent does not result in a loss in the yield stress that is a factor in achieving cling.

### Example 6

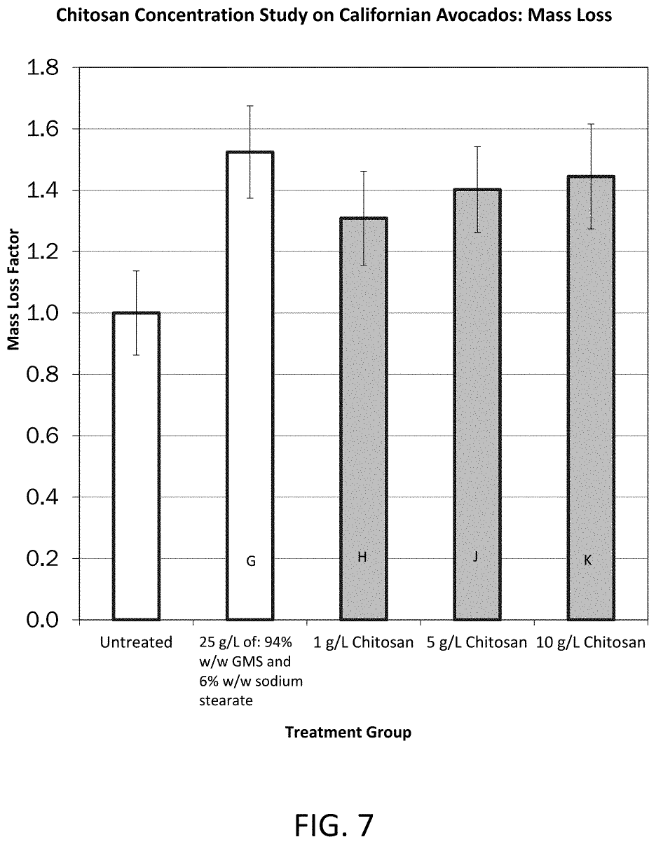

This example is a study of Chitosan concentration on Californian Avocados.
Purpose: To determine the effectiveness of chitosan as a water and gas barrier in terms of concentration on Californian avocados.
Experimental Design: 180 Californian avocados per group
Controls: Untreated and 25 g/L of: 94% w/w glyceryl monostearate and 6% w/w sodium stearate.
Treatments: Chitosan at 1 g/L, 5 g/L, and 10 g/L
Application Method: Bowl dip for chitosan, brush bed application for 94% w/w glyceryl monostearate and 6% w/w sodium stearate control.
Drying Method: Ambient dry
   Conclusion Mass loss factor has a positive correlation with chitosan concentration. FIG. 7 is a plot of mass loss factor of chitosan treated (gray data) and untreated (white data) Californian avocados.

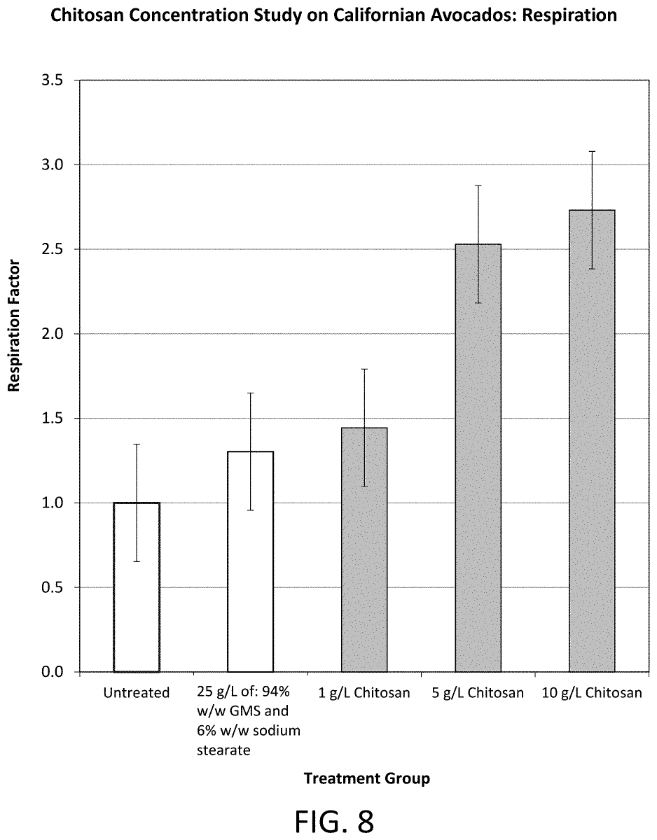

FIG. 8 is a plot of respiration of chitosan treated (gray data) and untreated (white data) Californian avocados. Respiration factor (RF) has a positive correlation with chitosan concentration. In comparison to the 25 g/L of: 94% w/w glyceryl monostearate and 6% w/w sodium stearate control, chitosan is a much better gas barrier. The control 25 g/L of: 94% w/w glyceryl monostearate and 6% w/w sodium stearate showed RF: 1.30×10 g/L and the chitosan RF: 2.73×.

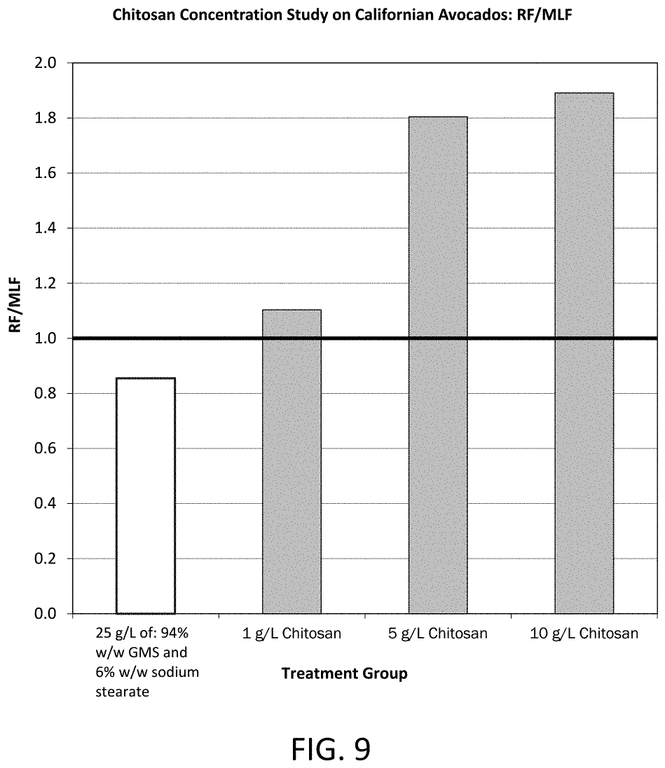

FIG. 9 is a plot of respiration/mass loss of chitosan treated (gray data) and untreated (white data) Californian avocados. The 25 g/L of: 94% w/w glyceryl monostearate and 6% w/w sodium stearate control had a RF/MLF ratio below 1, while the ratio for all chitosan solutions are above 1 RF/MLF ratio increases with increasing concentration of chitosan.

### Example 7

This example is a chitosan concentration study on Mexican avocados.
Purpose: To determine the effectiveness of chitosan as a water and gas barrier in terms of concentration.

### Experimental Design:

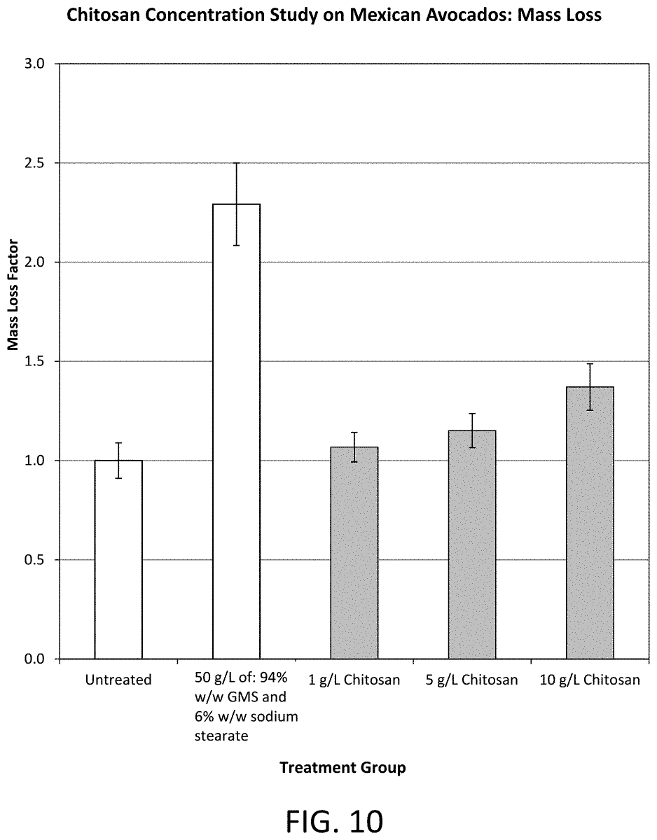

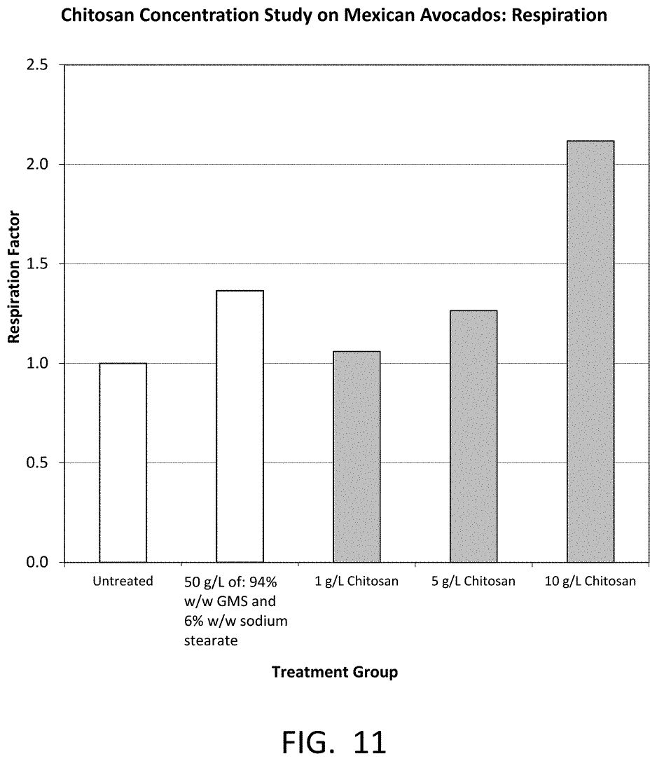

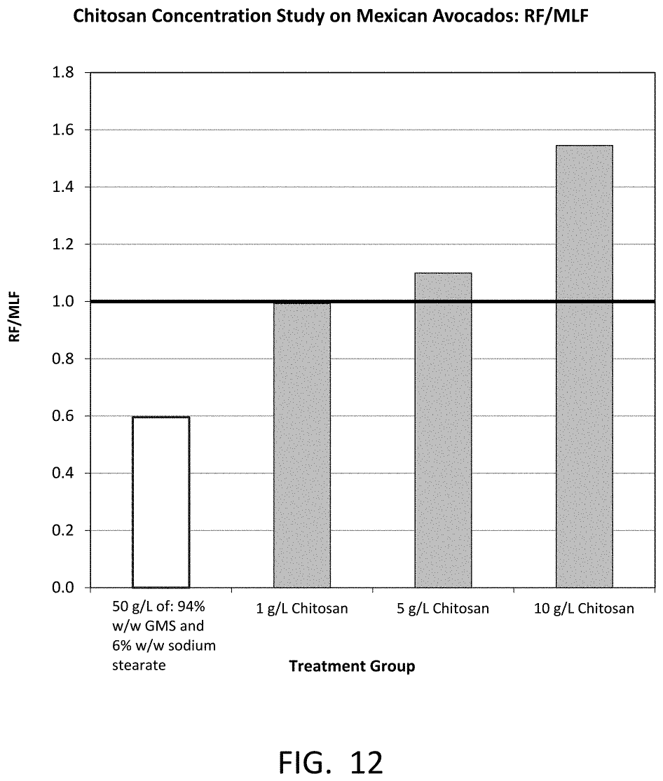

120 Mexican avocados per group
Control: Untreated, 50 g/L 94% w/w glyceryl monostearate and 6% w/w sodium stearate.
Treatment Groups: Chitosan at 1 g/L, 5 g/L, 10 g/L
Application Method: Bowl dip for chitosan, brush bed application for 94% w/w glyceryl monostearate and 6% w/w sodium stearate control.
Drying Method: Ambient dry
   Control: On Mexican avocados, mass loss factor increases with increasing concentration of chitosan. FIG. 10 is a plot of mass loss factor of chitosan concentration of treated (gray data) and untreated (white data) Mexican avocados. On Mexican avocados, respiration factor (RF) increases with increasing concentration of chitosan. Compared to the 94% w/w glyceryl monostearate and 6% w/w sodium stearate control, chitosan is a better gas barrier. The 94% w/w glyceryl monostearate and 6% w/w sodium stearate control had RF: 1.37×, and 10 g/L Chitosan RF: 2.12×. FIG. 11 is a plot of respiration factor of chitosan concentration of treated (gray data) and untreated (white data) Mexican avocados. The 94% w/w glyceryl monostearate and 6% w/w sodium stearate control has a RF/MLF ratio below 1, while the ratio for 5 g/L and 10 g/L chitosan are above 1. RF/MLF ratio increases with increasing concentration of chitosan. FIG. 12 is a plot of respiration/mass loss of chitosan treated (gray data) and untreated (white data) Mexican avocados.

### Example 8

### Chitosan Concentration Study on Peruvian Avocados: Respiration Factor.

Purpose: To determine the effectiveness of chitosan as a water and gas barrier in terms of concentration on Peruvian avocados.

### Experimental Design:

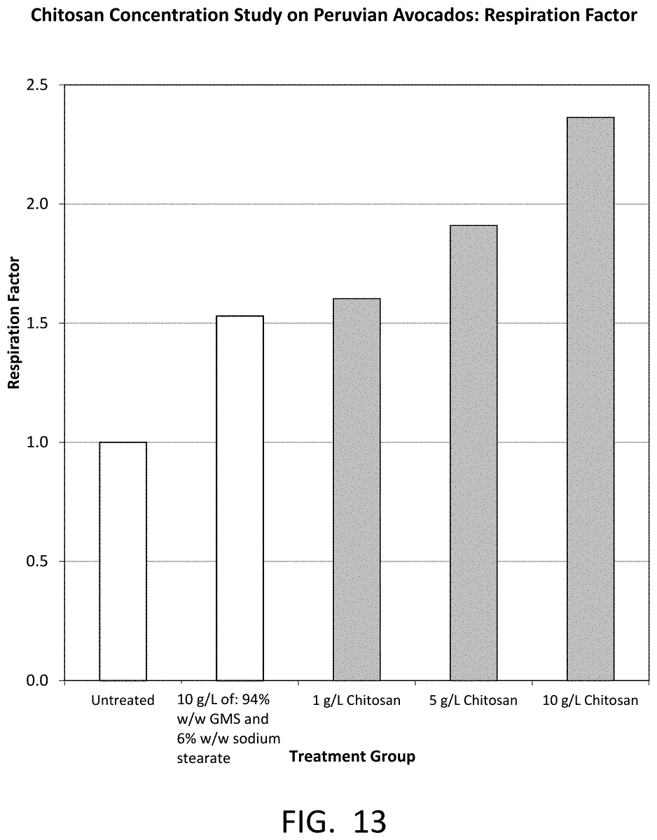

96 Peruvian avocados per group
Control: Untreated, 10 g/L 94% w/w glyceryl monostearate and 6% w/w sodium stearate.
Treatment Groups: Chitosan at 1 g/L, 5 g/L, 10 g/L
Application Method: Bowl dip for chitosan, brush bed application for 94% w/w glyceryl monostearate and 6% w/w sodium stearate control.
Drying Method: Ambient dry on racks
   Conclusion: Respiration factor is positively correlated to chitosan concentration.
   Chitosan is better gas barrier than 94% w/w glyceryl monostearate and 6% w/w sodium stearate control. The 94% w/w glyceryl monostearate and 6% w/w sodium stearate control had RF: 1.53×, and the 10 g/L Chitosan RF: 2.36×. FIG. 13 is a plot of respiration of chitosan concentration of treated (gray data) and untreated (white data) Peruvian avocados.

### Example 9

### Chitosan Concentration Study on Bosc Pears.

Purpose: To determine the effectiveness of chitosan as a water and gas barrier in terms of concentration on bosc pears.

### Experimental Design:

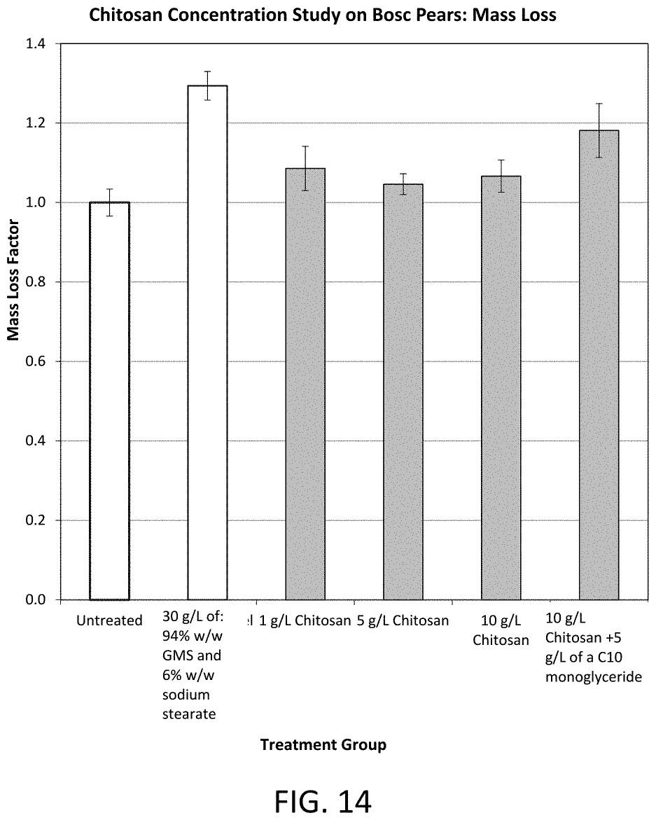

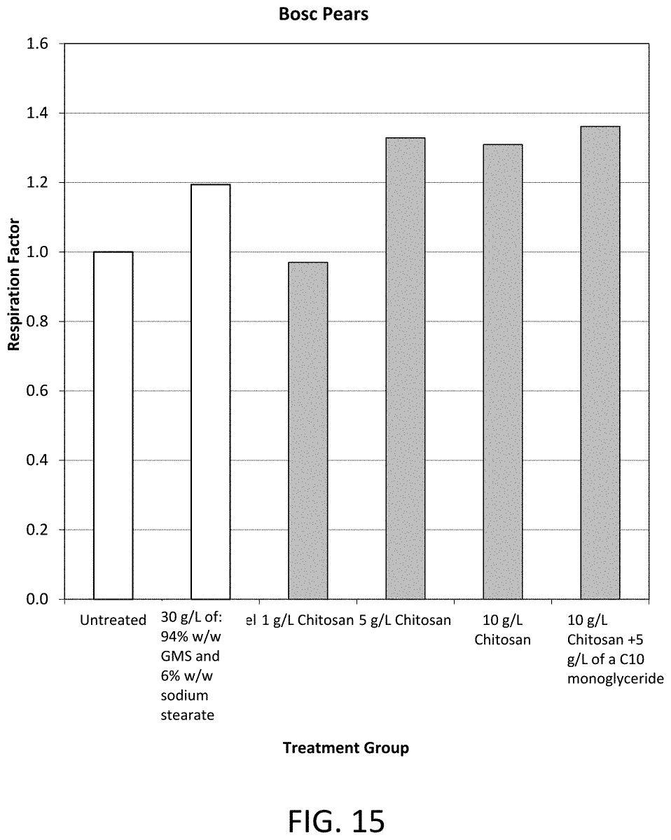

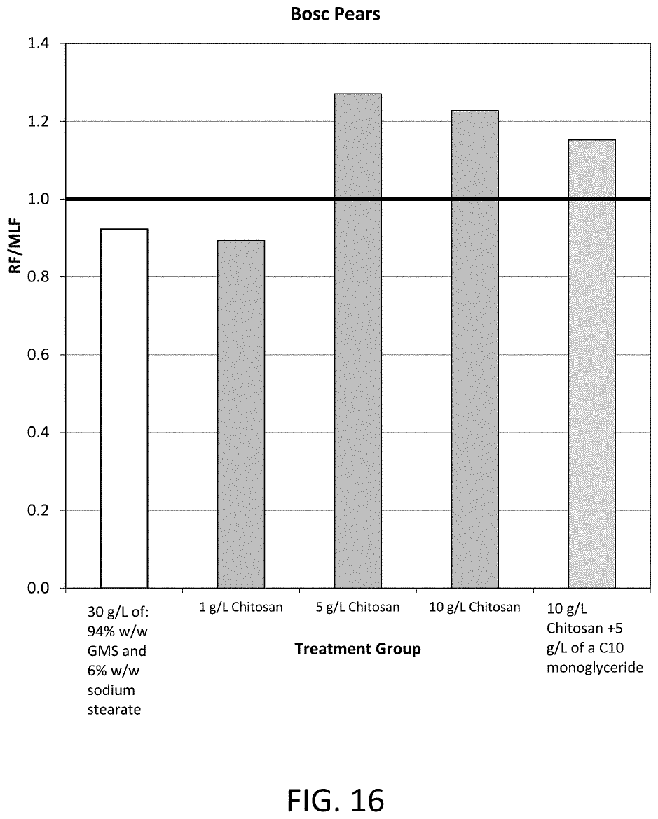

90 bosc pears per group Control: Untreated, 30 g/L 94% w/w glyceryl monostearate and 6% w/w sodium stearate.
Treatment Groups: Chitosan at 1 g/L, 5 g/L, 10 g/L, 10 g/L Chitosan+5 g/L a C10 monoglyceride (e.g., a C10 short chain monoglyceride).
   Conclusion: There was not a trend with mass loss factor and concentration of chitosan. The addition of a C10 monoglyceride increased mass loss performance. FIG. 14 is a plot of mass loss factor of chitosan concentration of treated (gray data) and untreated (white data) bosc pears. Chitosan has respiration performance at 5 g/L and above. The addition of a C10 monoglyceride did not change respiration performance. FIG. 15 is a plot of respiration of chitosan concentration of treated (gray data) and untreated (white data) bosc pears. Similar to avocados, the 30 g/L of: 94% w/w glyceryl monostearate and 6% w/w sodium stearate control has a RF/MLF below 1, while chitosan at 5 g/L and above have RF/MLF above 1. FIG. 16 is a plot of respiration/mass loss of chitosan treated (gray data) and untreated (white data) bosc pears.

### Example 10

Respiration Matching with Chitosan on Mexican Avocados.
Purpose: To single out the significance of mass loss factor on Mexican avocados with extending shelf life.

### Experimental Design

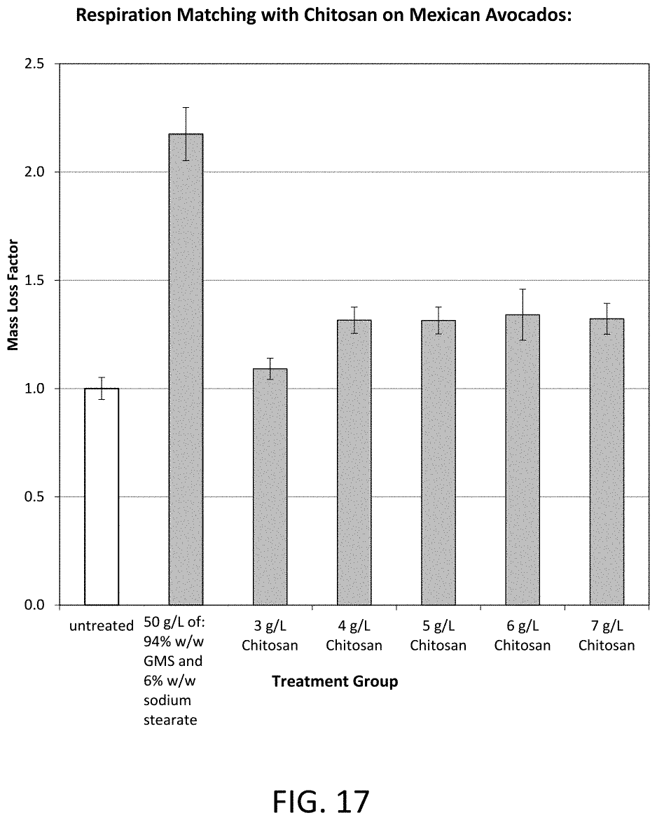

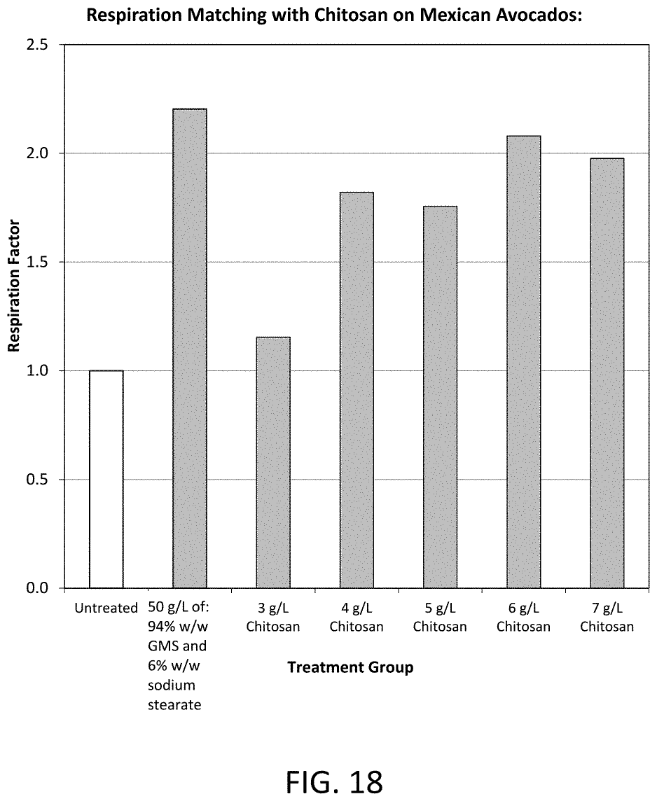

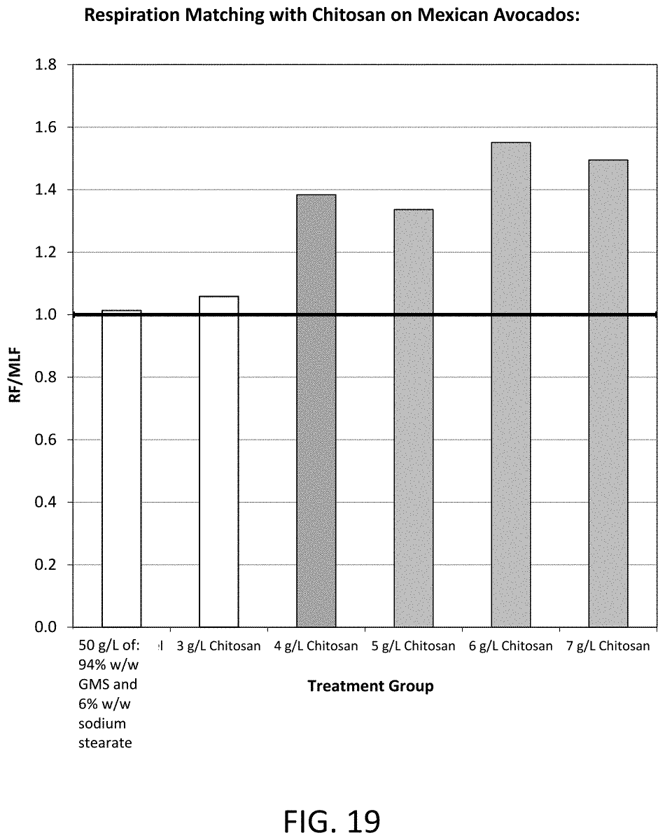

120 Mexican avocados per group.
Control: Untreated.
Treatments: 50 g/L of: 30 g/L 94% w/w glyceryl monostearate and 6% w/w sodium stearate, Chitosan at 3, 4, 5, 6, and 7 g/L.
   Conclusion: Chitosan solutions plateaued in mass loss factor at 4 g/L around 1.31×. FIG. 17 is a plot of mass loss factor respiration matching with chitosan on Mexican avocados. After two respiration points, the chitosan solutions all have a bit lower respiration factor than 50 g/L of: 30 g/L 94% w/w glyceryl monostearate and 6% w/w sodium stearate. FIG. 18 is a plot of respiration matching with chitosan treated (gray data) and untreated (white data) on Mexican avocados. Chitosan treated avocados all have an RF/MLF above 1, with the peak at 6 g/L. FIG. 19 is a plot of respiration matching with chitosan treated (gray data) and untreated (white data) on Mexican avocados.

### Example 11

This example demonstrates water vapor transmission rate of Avocados covered with a biopolymer and Avocados covered with a first coating and a second coating.

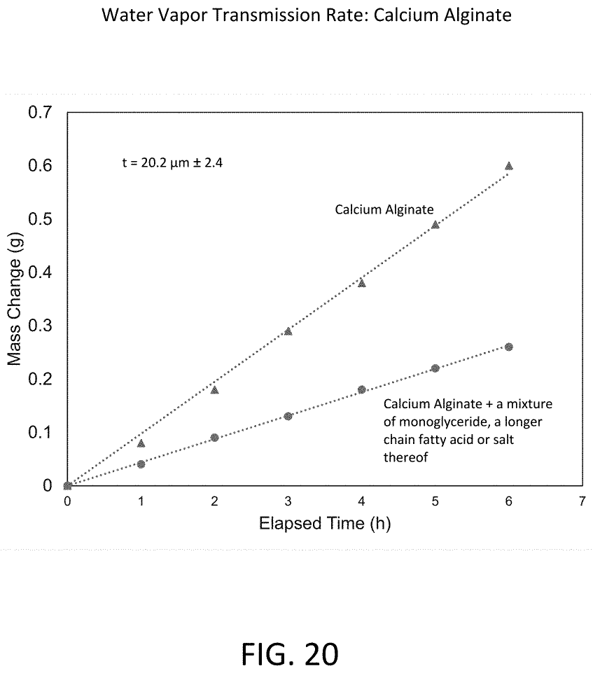

The water vapor transmission rate (WVTR) was measured for a calcium alginate film (e.g., a first coating) with and without a mixture of: monoglyceride and a fatty acid or salt (e.g., a second coating). The mixture of: monoglyceride and a fatty acid or salt at a concentration 30 g/L was applied to the surface of a crosslinked (insoluble) calcium alginate film via bowl dip and allowed to dry at room temperature overnight. The WVTR of the coated film was then measured in the same manner as the uncoated (as-prepared) film. The agricultural product with a coating of calcium alginate (e.g., a first coating) without a coating of a mixture of: monoglyceride and a fatty acid or salt (e.g., a second coating) showed a release of more water vapor than the agricultural product with both the first coating and the second coating. The agricultural product with both the first coating (calcium alginate) and the second coating (the mixture of: monoglyceride and a fatty acid or salt) resulted in an about 55% decrease in WVTR. The agricultural product with a coating of calcium alginate (e.g., a first coating) without a coating of a mixture of: monoglyceride and a fatty acid or salt (e.g., a second coating) showed a 1.99×10⁻³ g/cm² h. The agricultural product with both the first coating (calcium alginate) and the second coating (the mixture of: monoglyceride and a fatty acid or salt) showed a 0.894×10⁻³ g/cm² h. The results are shown in FIG. 20.

FIG. 20 is a plot of water vapor transmission measured by change in mass versus elapsed time of Avocados coated with calcium alginate (triangles) and calcium alginate and a mixture of monoglyceride, a fatty acid or salt thereof (circles).

### Example 12

This example demonstrates the viscoelastic behavior of mixtures of monoglyceride and fatty acid or a salt thereof with a protein in water. A dispersion of monoglyceride, a fatty acid or a salt thereof, soy protein isolate, and water was prepared by combining glycerol monostearate, sodium stearate, monolaurin, soy protein isolate, and water. The composition tested is shown below in Table 5.

TABLE 5
Soy protein isolate barrier film composition

| Component | Solid Weight % | Concentration g/L |
|---|---|---|
| Glycerol monostearate | 63.3 | 39.9 |
| Sodium stearate | 3.3 | 2.1 |
| Monolaurin | 3.3 | 2 |
| Soy protein isolate | 30 | 19 |

The following stock dispersions were prepared:
64 g/L soy protein isolate and deionized water prepared under ambient conditions with magnetic stir bar.
60 g/L of a monoglyceride and fatty acid dispersion of 95% glycerol monostearate and 5% sodium stearate and hot deionized water. Mixed on high speed in a blender.
3 g/L of monolaurin and hot deionized water. Mixed on high speed in a blender. Quantities of stock solutions were mixed together using a blender and mixing in high speed for 3 minutes to provide the sample according to Table 5. Produce was treated with the dispersion of Table 5 at ambient temperatures and at about 20° C. The treated produce was allowed to dry in a 75° C. heat tunnel and characteristics of the produce when coated were measured at different time points.

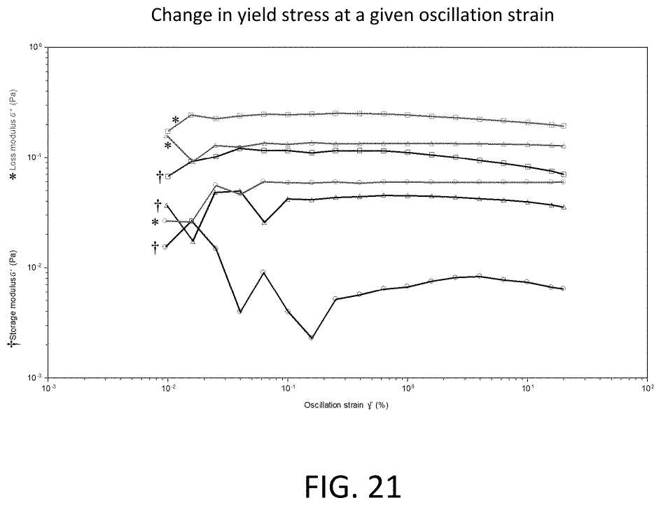

FIG. 21 is a plot that shows change in yield stress at a given oscillation strain of the barrier film composition of Table 5 various time points (e.g., at 5 days, 2 days, and fresh). The square denotes the barrier film composition of Table 5 at 5 days of age. The triangle denotes the barrier film composition of Table 5 at 2 days of age. The circle denotes the barrier film composition of Table 5 as a fresh sample. The symbol t denotes the storage (i.e., elastic) modulus, and the symbol * denotes the loss (i.e., viscous) modulus. FIG. 21 shows that the storage modulus and the loss modulus increases with age. The increase in the storage modulus and the loss modulus indicates an increase in solid-like behavior though the dispersion primarily behaves as a liquid. At 5 days of age, the barrier film composition has a yield stress of about 0.1 Pa.

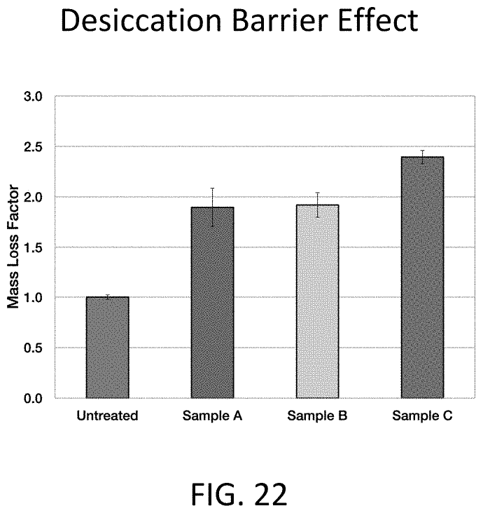

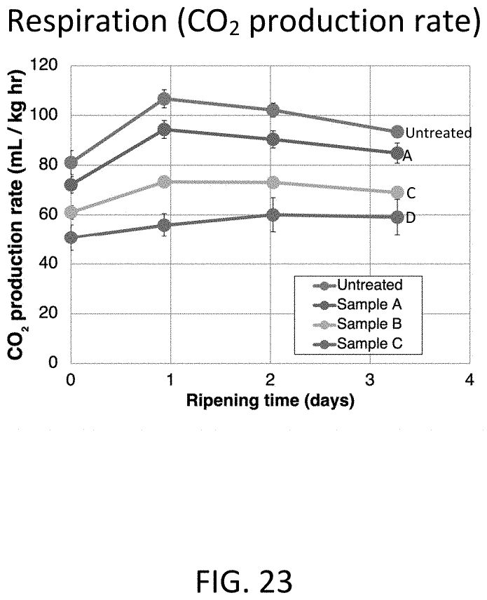

FIG. 22 shows the desiccation barrier effect of the barrier film composition of Table 5 on Haas avocados. The mass loss effect was measured on Haas avocados under the following conditions:
Untreated
Sample A=39.9 g/L glycerol monostearate, 2.1 g/L sodium stearate, 2 g/L monolaurin
Sample B=Sample A+19 g/L Soy Protein Isolate, 1-Day Aged
Sample C=Sample B, 7-Day Aged
   FIG. 23 shows the respiration (CO₂ production rate) of the barrier film composition of Table 5 on Haas avocados. The respiration was measured on Haas avocados under the following conditions:
Untreated
Sample A=39.9 g/L glycerol monostearate, 2.1 g/L sodium stearate, 2 g/L monolaurin
Sample B=Sample A+19 g/L Soy Protein Isolate, 1-Day Aged
Sample C=Sample B, 7-Day Aged

The results indicated that barrier film compositions prepared with a mixture of short and long-chain monoglycerides, fatty acid salts, and soy protein isolate increased the gas barrier, as evidenced by the reduction in respiration rate shown in FIG. 23. This could provide an option for selectively modulating the gas barrier, which is associated with ripening in produce such as avocados. The maintenance of moisture and firmness of the produce is also maintained. FIG. 21 and FIG. 22 show that the dispersions of Table 5 that were aged had an increase in shear elasticity and reduction in respiration rate, suggesting that the coating provides a greater resistance to gas transfer. The results indicate that the barrier film properties can be adjusted by chemical composition of the lipid/protein dispersion and its processing into a film (age of the dispersion).

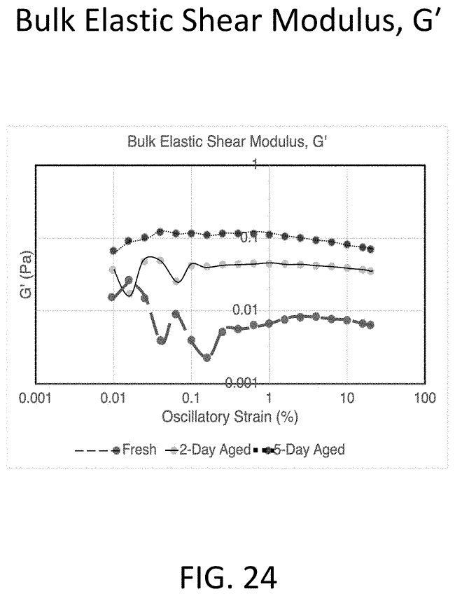

FIG. 24 shows the shear elasticity with dispersion age of the barrier film composition prepared with a mixture of short and long-chain monoglycerides, fatty acid salts, and soy protein isolate as denoted in Table 5. The broken line (bottom) is the fresh dispersion, the unbroken line (middle) is 2 day aged, and the dotted line (top) is 5 day aged. The shear elastic modulus, G′, increases with age of the dispersion. At 5 days (dotted top line), the dispersion has a yield stress of about 0.1 Pa.

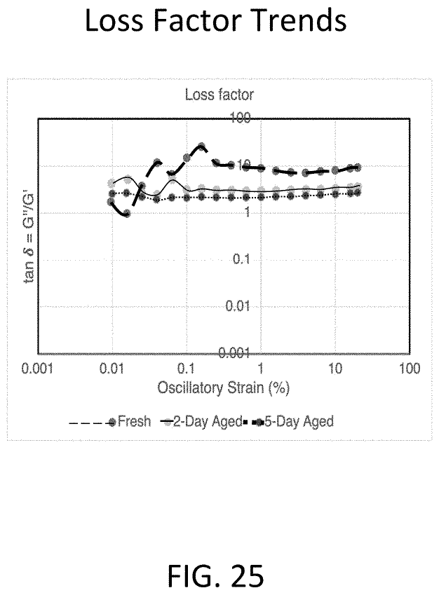

FIG. 25 shows loss factor trends with dispersion age of the barrier film composition prepared with a mixture of short and long-chain monoglycerides, fatty acid salts, and soy protein isolate as denoted in Table 5. The broken line (top) is the fresh dispersion, the unbroken line (middle) is 2 day aged, and the dotted line (bottom) is 5 day aged. Loss factor trends show that the liquid dispersion becomes more elastic with dispersion age. Given that the loss factor >1, the dispersion is primarily liquid-like in behavior, though it does increases in elasticity, or its ‘solid-like’ behavior, with dispersion age. This can be seen in how the value of the loss factor approaches 1 with dispersion age.

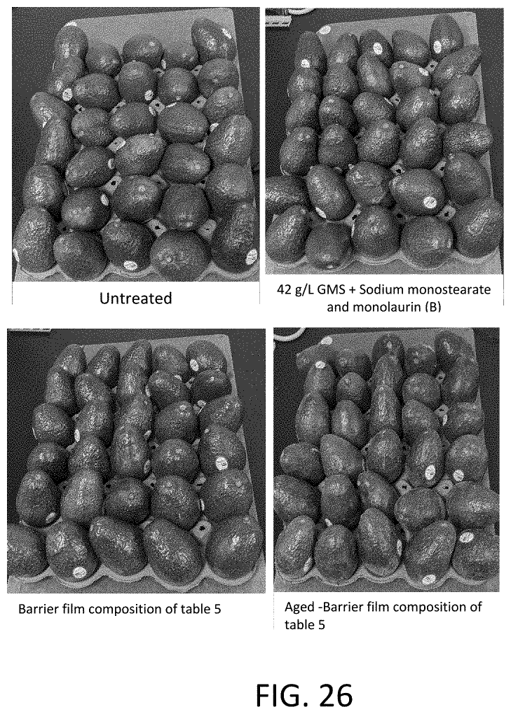

FIG. 26 shows avocados coated with the soy protein isolate dispersion described in Table 5 impart more shine than those without the described dispersion or the aged dispersion. The formulations described in Table 5 can confer added shine to fruits with rough surfaces, as demonstrated on avocados shown in FIG. 26 where the lower left panel imparts additional shine as compared to the other treatments.

### EMBODIMENTS

Embodiment 1 is a barrier film composition, comprising: a monoglyceride, a fatty acid or a salt thereof, a biopolymer, and water; wherein the barrier film composition has a yield stress of at least 0.1 Pa.

Embodiment 2 is the barrier film composition of embodiment 1, wherein the yield stress of about 0.1 Pa to about 6.0 Pa.

Embodiment 3 is the barrier film composition of embodiment 1 or embodiment 2, wherein the yield stress of the barrier film composition is about 2 Pa to about 5 Pa.

Embodiment 4 is the barrier film composition of embodiment 1 or embodiment 2, wherein the yield stress of the barrier film composition is about 0.3 Pa to about 0.7

Pa.

Embodiment 5 is the barrier film composition of embodiment 4, wherein the yield stress of the barrier film composition is about 0.5 Pa.

Embodiment 6 is the barrier film composition of embodiment 1, wherein the yield stress of the barrier film composition is about 0.8 Pa to about 1.4 Pa.

Embodiment 7 is the barrier film composition of embodiment 6, wherein the yield stress of the barrier film composition is about 1.1 Pa.

Embodiment 8 is the barrier film composition of embodiment 1 or embodiment 2, wherein the yield stress of the barrier film composition is about 0.1 Pa to about 6 Pa.

Embodiment 9 is the barrier film composition of embodiment 1 or embodiment 2, wherein the viscosity of the barrier film composition is about 0.001 Pa·s to about 0.1 Pa·s at a shear rate of 5000 s⁻¹.

Embodiment 10 is the barrier film composition of embodiment 1 or embodiment 2, wherein the yield stress of the barrier film composition is about 1 Pa to about 5 Pa.

Embodiment 11 is the barrier film composition of embodiment 1 or embodiment 2, wherein the viscosity of the barrier film composition at a shear rate of 5000 s⁻¹ is less than about 0.05 Pa·s.

Embodiment 12 is the barrier film composition of any one of embodiments 1-11, wherein the barrier film composition comprises about 5 g/L to about 150 g/L of the monoglyceride.

Embodiment 13 is the barrier film composition of any one of embodiments 1-12, wherein the barrier film composition comprises about 0.1 g/L to about 10 g/L of the fatty acid or a salt thereof.

Embodiment 14 is the barrier film composition of any one of embodiments 1-13, wherein the barrier film composition comprises about 1.5 g/L to about 8 g/L of the biopolymer.

Embodiment 15 is the barrier film composition of any one of embodiments 1-14, wherein the biopolymer is a polysaccharide, a protein, or a combination thereof.

Embodiment 16 is the barrier film composition of any one of embodiments 1-15, wherein the biopolymer is a polysaccharide.

Embodiment 17 is the barrier film composition of any one of embodiments 1-16, wherein the biopolymer is a network forming polysaccharide.

Embodiment 18 is the barrier film composition of any one of embodiments 1-17, wherein the biopolymer is selected from the group consisting of xanthan gum, guar gum, pectin, gum Arabic, carrageenan, potassium alginate, ammonium alginate, calcium alginate, sodium alginate, agar, cellulose, starch, chitosan, and a combination thereof.

Embodiment 19 is the barrier film composition of any one of embodiments 1-18, wherein the biopolymer is xanthan gum.

Embodiment 20 is the barrier film composition of any one of embodiments 1-18, wherein the biopolymer is chitosan.

Embodiment 21 is the barrier film composition any one of embodiments 1-18, wherein the biopolymer is calcium alginate.

Embodiment 22 is the barrier film composition of any one of embodiments 1-21, wherein the biopolymer is a protein.

Embodiment 23 is the barrier film composition of embodiment 22, wherein the protein is selected from the group consisting of soy protein isolate, wheat gluten, collagen, whey protein isolate, albumen, zein, chickpea protein isolate, caseinate, gelatin, and a combination thereof.

Embodiment 24 is the barrier film composition of any one of embodiments 1-23, wherein the monoglyceride has a carbon chain length of about C10 to about C20.

Embodiment 25 is the barrier film composition of any one of embodiments 1-24, wherein the monoglyceride has a carbon chain length selected from the group consisting of a C10 monoglyceride, a C12 monoglyceride, a C14 monoglyceride, a C16 monoglyceride, a C18 monoglyceride, a C20 monoglyceride, and a combination thereof.

Embodiment 26 is the barrier film composition of any one of embodiments 1-25, wherein the monoglyceride is a saturated monoglyceride.

Embodiment 27 is the barrier film composition of any one of embodiments 1-26, wherein the monoglyceride is glyceryl monostearate.

Embodiment 28 is the barrier film composition of any one of embodiments 1-27 wherein the yield stress is measured at a temperature of about 20° C. to about 30° C.

Embodiment 29 is the barrier film composition of any one of embodiments 1-28, wherein the yield stress is measured at a temperature of about 25° C.

Embodiment 30 is the barrier film composition of any one of embodiments 1-29, wherein the barrier film composition further comprises one or more wetting agents.

Embodiment 31 is the barrier film composition of any one of embodiments 1-29, wherein the barrier film composition further comprises one or more wetting agents and a polysaccharide.

Embodiment 32 is the barrier film composition of embodiment 31, wherein the barrier film composition has a yield stress greater than 1.2 Pa.

Embodiment 33 is the barrier film composition of any one of embodiments 1-32, wherein the barrier film composition further comprises an anionic surfactant.

Embodiment 34 is the barrier film composition of embodiment 33, wherein the anionic surfactant is selected from the group consisting of sodium decyl sulfate, sodium N-lauroyl-N-methyltaurate, sodium tetradecyl sulfate, sodium dodecyl sulfate, and a combination thereof.

Embodiment 35 is the barrier film composition of any one of embodiments 1-34, wherein the barrier film composition further comprises an additive.

Embodiment 36 is the barrier film composition of embodiment 35, wherein the additive is selected from the group consisting of a preservative, a stabilizer, a buffer a vitamin, a mineral, a pH modifier, a salt, a pigment, a fragrance, an enzyme, a catalyst, an anti-oxidant, an antifungal, an antimicrobial, or a combination thereof.

Embodiment 37 is a method of coating plant matter, the method comprising: providing a barrier film composition of any one of embodiments 1-27; and applying the barrier film composition onto a surface of the plant matter.

Embodiment 38 is the method of embodiment 37, wherein applying the barrier film composition to the surface of the plant matter comprises dipping the plant matter into the barrier film composition.

Embodiment 39 is the method of embodiment 36 or embodiment 37, wherein applying the barrier film composition to the surface of the plant matter comprises spraying the barrier film composition onto the surface of the plant matter.

Embodiment 40 is the method of any one of embodiments 37-39, wherein following application of the barrier film composition, the rate of water loss from the plant matter is reduced.

Embodiment 41 is the method of any one of embodiments 37-40, wherein following application of the barrier film composition, the rate of CO₂ production by the plant matter is reduced.

Embodiment 42 is the method of any one of embodiments 37-41, wherein following application of the barrier film composition, the rate of mass loss of the plant matter is reduced.

Embodiment 43 is the method of any one if embodiments 37-42, further comprising allowing the barrier film composition to at least partially evaporate for a period time of about 30 seconds to about 180 seconds.

Embodiment 44 is the method of embodiment 43, wherein the period of time is about 100 seconds.

Embodiment 45 is the method of any one of embodiments 37-44, further comprising homogenizing the barrier film composition prior to application to the plant matter.

Embodiment 46 is the method of any one of embodiments 37-45, wherein the water is heated to a temperature of about 60° C. to about 100° C.

Embodiment 47 is the method of any one of embodiments 37-46, wherein the plant matter is selected from the group consisting of a fruit, a vegetable, a leaf, a stem, bark, a seed, a flower, a peel, a root, and a combination thereof.

Embodiment 48 is the method of any one of embodiments 37-46, wherein the barrier film composition is applied to the plant matter pre-harvest.

Embodiment 49 is the method of any one of embodiments 37-47, wherein the barrier film composition is applied to the plant matter post-harvest.

Embodiment 50 is a coated agricultural product comprising a coating of the barrier film composition of any one of embodiments 1-36, on a surface of the agricultural product.

Embodiment 51 is the coated agricultural product of embodiment 50, wherein the barrier film composition is coated on the agricultural product pre-harvest.

Embodiment 52 is the agricultural product of embodiment 50, wherein the barrier film composition is coated on the agricultural product post-harvest.

Embodiment 53 is the agricultural product of any one of embodiments 50-52, wherein the agricultural product has been portioned.

Embodiment 54 is the agricultural product of any one of embodiments 50-53, wherein the agricultural product is a meat, a plant, a fungus, or a combination thereof. Embodiment 55 is the agricultural product of embodiment 54, wherein the meat is derived from the group consisting of beef, lamb, poultry, pork, fish, shell-fish, boar, bison, deer, elk, camel, boar, rodent, and a combination thereof.

Embodiment 56 is the agricultural product of embodiment 54, wherein the plant is plant matter selected from the group consisting of a fruit, a vegetable, a leaf, a stem, bark, a seed, a flower, a peel, a root, and a combination thereof.

Embodiment 57 is the agricultural product of embodiment 56, wherein the plant matter is a flower.

Embodiment 58 is the agricultural product of embodiment 56, wherein the plant matter is a fruit.

Embodiment 59 is the agricultural product of embodiment 56, wherein the plant matter is a vegetable.

Embodiment 60 is a coated agricultural product, comprising: an agricultural product having a surface; and a coating on the surface comprising: a monoglyceride, a fatty acid or a salt thereof, a biopolymer, and water.

Embodiment 61 is the coated agricultural product of embodiment 60, wherein the coating comprises about 5 g/L to about 150 g/L of the monoglyceride.

Embodiment 62 is the coated agricultural product of embodiment 60 or embodiment 61, wherein the coating comprises about 0.1 g/L to about 10 g/L of the fatty acid or a salt thereof.

Embodiment 63 is the coated agricultural product of any one of embodiments 60-62, wherein the coating comprises the biopolymer at about a 1M concentration.

Embodiment 64 is the coated agricultural product of any one of embodiments 60-63, wherein the biopolymer is a polysaccharide.

Embodiment 65 is the coated agricultural product of any one of embodiments 60-64, wherein the biopolymer is a network forming polysaccharide.

Embodiment 66 is the coated agricultural product of any one of embodiments 60-65, wherein the polysaccharide is selected from the group consisting of xanthan gum, guar gum, pectin, gum arabic, carrageenan, potassium alginate, ammonium alginate, calcium alginate, sodium alginate, agar, cellulose, starch, chitosan, and a combination thereof.

Embodiment 67 is the coated agricultural product of any one of embodiments 60-66, wherein the biopolymer is xanthan gum.

Embodiment 68 is the coated agricultural product of any one of embodiments 60-66, wherein the biopolymer is chitosan.

Embodiment 69 is the coated agricultural product of any one of embodiments 60-66, wherein the biopolymer is calcium alginate.

Embodiment 70 is the coated agricultural product of embodiment 69, wherein the calcium alginate is crosslinked.

Embodiment 71 is the coated agricultural product of any one of embodiments 60-70, wherein the monoglyceride has a carbon chain length of about C10 to about C20.

Embodiment 72 is the coated agricultural product of any one of embodiments 60-71, wherein the monoglyceride has a carbon chain length selected from the group consisting of a C10 monoglyceride, a C12 monoglyceride, a C14 monoglyceride, a C16 monoglyceride, a C18 monoglyceride, a C20 monoglyceride, and a combination thereof.

Embodiment 73 is the coated agricultural product of any one of embodiments 60-72, wherein the monoglyceride is a saturated monoglyceride.

Embodiment 74 is the coated agricultural product of any one of embodiments 60-73, wherein the monoglyceride is glyceryl monostearate.

Embodiment 75 is the coated agricultural product of any one of embodiments 60-74, wherein the coating further comprises one or more wetting agents.

Embodiment 76 is the coated agricultural product of any one of embodiments 60-75, wherein the coating further comprises an anionic surfactant.

Embodiment 77 is the coated agricultural product of embodiment 76, wherein the anionic surfactant is selected from the group consisting of sodium decyl sulfate, sodium N-lauroyl-N-methyltaurate, sodium tetradecyl sulfate, sodium dodecyl sulfate, and a combination thereof.

Embodiment 78 is the coated agricultural product of any one of embodiments 60-77, wherein the coating of the coated agricultural product further comprises an additive.

Embodiment 79 is the coated agricultural product of embodiment 78, wherein the additive is selected from the group consisting of a preservative, a stabilizer, a buffer a vitamin, a mineral, a pH modifier, a salt, a pigment, a fragrance, an enzyme, a catalyst, an anti-oxidant, an antifungal, an antimicrobial, or a combination thereof.

Embodiment 80 is the coated agricultural product of any one of embodiments 60-79, wherein the agricultural product has been portioned.

Embodiment 81 is the coated agricultural product of any one of embodiments 60-80, wherein the agricultural product is a meat, a plant, a fungus, or a combination thereof.

Embodiment 82 is the coated agricultural product of embodiment 81, wherein the meat is derived from the group consisting of beef, lamb, poultry, pork, fish, shell-fish, boar, bison, deer, elk, camel, boar, rodent, and a combination thereof.

Embodiment 83 is the coated agricultural product of embodiment 81, wherein the plant is plant matter selected from the group consisting of a fruit, a vegetable, a leaf, a stem, bark, a seed, a flower, a peel, a root, and a combination thereof.

Embodiment 84 is the coated agricultural product of embodiment 83, wherein the plant matter is a flower.

Embodiment 85 is the coated agricultural product of embodiment 83, wherein the plant matter is a fruit.

Embodiment 86 is the coated agricultural product of embodiment 83, wherein the plant matter is a vegetable.

Embodiment 87 is a method of coating an agricultural product, the method comprising: (a) providing a first coating comprising a biopolymer and water; (b) applying the first coating onto a surface of the agricultural product; (c) providing a second coating comprising a monoglyceride, a fatty acid salt, and water; and (d) applying the second coating to the surface of agricultural product.

Embodiment 88 is the method of embodiment 88, wherein the coating comprises about the biopolymer at about a 1M concentration.

Embodiment 89 is the method of any one of embodiment 87 or embodiment 88, wherein the biopolymer is a polysaccharide.

Embodiment 90 is the method of any one of embodiments 87-89, wherein the biopolymer is a network forming polysaccharide.

Embodiment 91 is the method of any one of embodiments 87-89, wherein the polysaccharide is selected from the group consisting of xanthan gum, guar gum, pectin, gum arabic, carrageenan, potassium alginate, ammonium alginate, calcium alginate, sodium alginate, agar, cellulose, starch, chitosan, and a combination thereof.

Embodiment 92 is the method of any one of embodiments 87-91, wherein the biopolymer is xanthan gum.

Embodiment 93 is the method of any one of embodiments 87-91, wherein the biopolymer is chitosan.

Embodiment 94 is the method of any one of embodiments 87-91, wherein the biopolymer is calcium alginate.

Embodiment 95 is the method of embodiment 94, wherein prior to (b) the calcium alginate is crosslinked.

Embodiment 96 is the method of any one of embodiments 87-95, further comprising, allowing the first coating to dry for a period of time prior to (d).

Embodiment 97 is the method of embodiment 96, wherein the period of time is about 40 minutes to about 80 minutes.

Embodiment 98 is the method of embodiment 96 or embodiment 97, wherein the period of time is about 60 minutes.

Embodiment 99 is the method of any one of embodiments 87-98, further comprising prior to (c) allowing the first coating to dry at a temperature of about 30° C. to about 50° C.

Embodiment 100 is the method of embodiment 99, further comprising allowing the first coating to dry at a temperature of about 40° C.

Embodiment 101 is the method of any one of embodiments 86-100, wherein applying the second coating to the surface of the agricultural product over the first coating comprises dipping the plant matter into the second coating.

Embodiment 102 is the method of any one of embodiments 87-100, wherein applying the second coating to the surface of the agricultural product over the first coating comprises spraying the second coating onto the surface of the agricultural product.

Embodiment 103 is the method of any one of embodiments 87-102, wherein following application of the second coating, the rate of water loss from the agricultural product is reduced.

Embodiment 104 is the method of any one of embodiments 87-103, wherein following application of second coating, the rate of CO₂ production by the agricultural product is reduced.

Embodiment 105 is the method of any one of embodiments 87-104, wherein following application of the second coating, the rate of mass loss of the agricultural product is reduced.

Embodiment 106 is the coated agricultural product of embodiment 105, wherein the first coating and the second coating are coated on the agricultural product pre-harvest.

Embodiment 107 is the agricultural product of embodiment 105, wherein the first coating and the second coating are coated on the agricultural product post-harvest.

Embodiment 108 is the agricultural product of any one of embodiments 87-107, wherein the agricultural product has been portioned.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A barrier film composition, comprising:
a monoglyceride;
a fatty acid or a salt thereof;
a biopolymer; and
water,
wherein the barrier film composition has a yield stress of at least 0.1 Pa as assessed by oscillatory rheology at 1 Hz and 25° C.

2. The barrier film composition of claim 1, wherein the yield stress is about 0.1 Pa to about 6 Pa, about 2 Pa to about 5 Pa, about 0.3 Pa to about 0.7 Pa, or about 0.8 Pa to about 1.4 Pa.

3. The barrier film composition of claim 1, wherein the viscosity of the barrier film composition is about 0.001 Pa·s to about 0.1 Pa·s at a shear rate of 5000 s−1 and at a temperature of 25° C.

4. The barrier film composition of claim 1, wherein the barrier film composition comprises about 5 g/L to about 150 g/L of the monoglyceride.

5. The barrier film composition of claim 1, wherein the barrier film composition comprises about 0.1 g/L to about 10 g/L of the fatty acid or a salt thereof.

6. The barrier film composition of claim 1, wherein the barrier film composition comprises about 1.5 g/L to about 8 g/L of the biopolymer.

7. The barrier film composition claim 1, wherein the biopolymer comprises a polysaccharide, a protein, or a combination thereof.

8. The barrier film composition of claim 1, wherein the biopolymer comprises xanthan gum, guar gum, pectin, gum Arabic, carrageenan, potassium alginate, ammonium alginate, calcium alginate, sodium alginate, agar, cellulose, starch, chitosan, or a combination thereof.

9. The barrier film composition of claim 1, wherein the biopolymer comprises soy protein isolate, wheat gluten, collagen, whey protein isolate, albumen, zein, chickpea protein isolate, caseinate, gelatin, or a combination thereof.

10. The barrier film composition of claim 1, wherein the monoglyceride has a carbon chain length of about C10 to about C20.

11. The barrier film composition of claim 1, further comprising one or more wetting agents.

12. The barrier film composition claim 1, further comprising an anionic surfactant.

13. The barrier film composition of claim 12, wherein the anionic surfactant comprises sodium decyl sulfate, sodium N-lauroyl-N-methyltaurate, sodium tetradecyl sulfate, sodium dodecyl sulfate, or a combination thereof.

14. A method of coating plant matter, the method comprising:
applying the barrier film composition of claim 1 to a surface of the plant matter.

15. The method of claim 14, wherein applying the barrier film composition to the surface of the plant matter comprises dipping the plant matter into the barrier film composition or spraying the barrier film composition onto the surface of the plant matter.

16. The method of claim 14, wherein following application of the barrier film composition, the rate of water loss from the plant matter is reduced.

17. The method of claim 14, wherein following application of the barrier film composition, the rate of CO2 production by the plant matter is reduced.

18. The method of claim 14, wherein following application of the barrier film composition, the rate of mass loss of the plant matter is reduced.

19. The method of claim 14, further comprising allowing the barrier film composition to at least partially evaporate for a period time of about 30 seconds to about 180 seconds.

20. The method of claim 14, wherein the plant matter comprises a fruit, a vegetable, a leaf, a stem, bark, a seed, a flower, a peel, a root, or a combination thereof.
